(19) United States
(12) Patent Application Publication
(10) Pub. No.: US 2026/0046933 A1
(43) Pub. Date: Feb. 12, 2026

(54) MULTIPLE PHYSICAL RANDOM ACCESS CHANNEL PREAMBLE TRANSMISSIONS BY A USER EQUIPMENT

(71) Applicant: QUALCOMM Incorporated, San Diego, CA (US)

(72) Inventors: Raviteja PATCHAVA, San Diego, CA (US); Jing SUN, San Diego, CA (US); Junyi LI, Greentown, PA (US); Xiaoxia ZHANG, San Diego, CA (US); Jing JIANG, San Diego, CA (US)

(21) Appl. No.: 18/800,671

(22) Filed: Aug. 12, 2024

(51) Int. Cl. H04W 74/0833; H04W 72/1268; H04W 74/08

(52) U.S. Cl. CPC H04W 74/0833; H04W 72/1268; H04W 74/0866

(57) ABSTRACT

Various aspects of the present disclosure generally relate to wireless communication. In some aspects, a user equipment (UE) may receive system information associated with a network node, the system information indicating multiple physical random access channel (PRACH) preambles to use for a random access channel (RACH) procedure with the network node. The UE may transmit, as part of the RACH procedure with the network node, a first transmission comprising a first PRACH preamble of the multiple PRACH preambles and a second transmission comprising a second PRACH preamble of the multiple PRACH preambles. Numerous other aspects are described.

### FIELD OF THE DISCLOSURE

Aspects of the present disclosure generally relate to wireless communication and specifically relate to techniques, apparatuses, and methods for multiple physical random access channel preamble transmissions by a user equipment.

### BACKGROUND

Wireless communication systems are widely deployed to provide various services that may include carrying voice, text, messaging, video, data, and/or other traffic. The services may include unicast, multicast, and/or broadcast services, among other examples. Typical wireless communication systems may employ multiple-access radio access technologies (RATs) capable of supporting communication with multiple users by sharing available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

The above multiple-access RATs have been adopted in various telecommunication standards to provide common protocols that enable different wireless communication devices to communicate on a municipal, national, regional, or global level. An example telecommunication standard is New Radio (NR). NR, which may also be referred to as 5G, is part of a continuous mobile broadband evolution promulgated by the Third Generation Partnership Project (3GPP). NR (and other mobile broadband evolutions beyond NR) may be designed to better support Internet of things (IoT) and reduced capability device deployments, industrial connectivity, millimeter wave (mmWave) expansion, licensed and unlicensed spectrum access, non-terrestrial network (NTN) deployment, sidelink and other device-to-device direct communication technologies (for example, cellular vehicle-to-everything (CV2X) communication), massive multiple-input multiple-output (MIMO), disaggregated network architectures and network topology expansions, multiple-subscriber implementations, high-precision positioning, and/or radio frequency (RF) sensing, among other examples. As the demand for mobile broadband access continues to increase, further improvements in NR may be implemented, and other radio access technologies such as 6G may be introduced, to further advance mobile broadband evolution.

### SUMMARY

Some aspects described herein relate to a method of wireless communication performed by a user equipment (UE). The method may include receiving, by the UE, system information associated with a network node, the system information indicating multiple physical random access channel (PRACH) preambles to use for a random access channel (RACH) procedure with the network node. The method may include transmitting, by the UE and as part of the RACH procedure with the network node, a first transmission comprising a first PRACH preamble of the multiple PRACH preambles and a second transmission comprising a second PRACH preamble of the multiple PRACH preambles.

Some aspects described herein relate to a method of wireless communication performed by a network node. The method may include receiving, by the network node, a first transmission comprising a PRACH preamble and a second transmission comprising the PRACH preamble. The method may include transmitting, by the network node, a response message associated with the PRACH preamble, the response message comprising, a first timing advance associated with the first transmission, and a second timing advance associated with the second transmission.

Some aspects described herein relate to an apparatus for wireless communication at a UE. The apparatus may include one or more memories and one or more processors coupled to the one or more memories. The one or more processors, individually or collectively and based at least in part on information stored in the one or more memories, may be configured to receive system information associated with a network node, the system information indicating multiple PRACH preambles to use for a RACH procedure with the network node. The one or more processors, individually or collectively and based at least in part on information stored in the one or more memories, may be configured to transmit, as part of the RACH procedure with the network node, a first transmission comprising a first PRACH preamble of the multiple PRACH preambles and a second transmission comprising a second PRACH preamble of the multiple PRACH preambles.

Some aspects described herein relate to an apparatus for wireless communication at a network node. The apparatus may include one or more memories and one or more processors coupled to the one or more memories. The one or more processors, individually or collectively and based at least in part on information stored in the one or more memories, may be configured to receive a first transmission comprising a PRACH preamble and a second transmission comprising the PRACH preamble. The one or more processors, individually or collectively and based at least in part on information stored in the one or more memories, may be configured to transmit a response message associated with the PRACH preamble, the response message comprising, a first timing advance associated with the first transmission, and a second timing advance associated with the second transmission.

Some aspects described herein relate to a non-transitory computer-readable medium that stores a set of instructions for wireless communication by a UE. The set of instructions, when executed by one or more processors of the UE, may cause the UE to receive system information associated with a network node, the system information indicating multiple PRACH preambles to use for a RACH procedure with the network node. The set of instructions, when executed by one or more processors of the UE, may cause the UE to transmit, as part of the RACH procedure with the network node, a first transmission comprising a first PRACH preamble of the multiple PRACH preambles and a second transmission comprising a second PRACH preamble of the multiple PRACH preambles.

Some aspects described herein relate to a non-transitory computer-readable medium that stores a set of instructions for wireless communication by a network node. The set of instructions, when executed by one or more processors of the network node, may cause the network node to receive a first transmission comprising a PRACH preamble and a second transmission comprising the PRACH preamble. The set of instructions, when executed by one or more processors of the network node, may cause the network node to transmit a response message associated with the PRACH preamble, the response message comprising, a first timing advance associated with the first transmission, and a second timing advance associated with the second transmission.

Some aspects described herein relate to an apparatus for wireless communication. The apparatus may include means for receiving system information associated with a network node, the system information indicating multiple PRACH preambles to use for a RACH procedure with the network node. The apparatus may include means for transmitting, as part of the RACH procedure with the network node, a first transmission comprising a first PRACH preamble of the multiple PRACH preambles and a second transmission comprising a second PRACH preamble of the multiple PRACH preambles.

Some aspects described herein relate to an apparatus for wireless communication. The apparatus may include means for receiving a first transmission comprising a PRACH preamble and a second transmission comprising the PRACH preamble. The apparatus may include means for transmitting a response message associated with the PRACH preamble, the response message comprising, a first timing advance associated with the first transmission, and a second timing advance associated with the second transmission.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, the specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure, but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network, in accordance with the present disclosure.

FIG. 2 is a diagram illustrating an example network node in communication with an example user equipment (UE) in a wireless network, in accordance with the present disclosure.

FIG. 3 is a diagram illustrating an example disaggregated base station architecture, in accordance with the present disclosure.

FIGS. 4A and 4B are diagrams illustrating a first example of a four-step random access procedure and a second example of a two-step random access procedure, respectively, in accordance with the present disclosure.

FIG. 5 is a diagram illustrating an example of a collision probability graph, in accordance with the present disclosure.

FIGS. 6A, 6B, 6C, and 6D are diagrams illustrating a first example, a second example, a third example, and a fourth example, respectively of multiple physical random access channel transmissions, in accordance with the present disclosure.

FIG. 7 is a diagram illustrating an example of a wireless communication process between a network node and a UE, in accordance with the present disclosure.

FIG. 8 is a diagram illustrating an example process performed, for example, at a UE or an apparatus of a UE, in accordance with the present disclosure.

FIG. 9 is a diagram illustrating an example process performed, for example, at a network node or an apparatus of a network node, in accordance with the present disclosure.

FIG. 10 is a diagram of an example apparatus for wireless communication, in accordance with the present disclosure.

FIG. 11 is a diagram of an example apparatus for wireless communication, in accordance with the present disclosure.

### DETAILED DESCRIPTION

Various aspects of the present disclosure are described hereinafter with reference to the accompanying drawings. However, aspects of the present disclosure may be embodied in many different forms and is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

“Physical random access channel (PRACH) collision” denotes an event in a wireless network where at least two user equipments (UEs) choose a same PRACH resource (e.g., a random access occasion (RO) and PRACH preamble and/or sequence) to transmit PRACH transmissions at the same time, resulting in a collision. Alternatively, or additionally, “PRACH collision” may denote a network node detecting a cyclic shift (CS) for a PRACH preamble, and deriving that multiple UEs are transmitting the CS. A network node may have difficulty identifying and/or may be unable to distinguish between the UEs associated with the collision. Accordingly, the network node may detect the collision as a single UE, and consequently transmit a single random access response (RAR) that includes a single uplink grant. Based at least in part on transmitting on the same RO and/or using a same PRACH preamble, the two UEs may both receive the single RAR and may both use the single uplink grant, resulting in a second collision in the uplink grant. The PRACH collision in combination with the second collision may collectively be referred to as a sequence domain collision. The probability of a PRACH collision and/or a sequence domain collision occurring may proportionally increase with an increase in a number of UEs accessing a wireless network. The occurrence of a PRACH collision and/or a sequence domain collision may result in a UE failing to access a wireless network and/or experiencing an increased latency in accessing the wireless network.

Various aspects relate generally to multiple PRACH preamble transmissions by a UE. Some aspects more specifically relate to the UE transmitting the multiple PRACH preamble transmissions in a same PRACH repetition cycle (e.g., either through multiple ROs or multiple PRACH preambles in the same RO) and/or a same PRACH configuration period (e.g., a time interval allocated and/or indicated by a network node for initial first message transmissions). In some aspects, a UE may receive system information associated with a network node, and the system information may indicate multiple PRACH preambles to use for a random access channel (RACH) procedure with the network node. Based at least in part on receiving the system information, the UE may transmit, as part of the RACH procedure with the network node, a first transmission comprising a first PRACH preamble of the multiple PRACH preambles and a second transmission comprising a second PRACH preamble of the multiple PRACH preambles. The first transmission and the second transmission may each be a respective first message of the RACH procedure (e.g., a respective msg1 or a respective msgA). In some aspects, the UE may transmit the first transmission and the second transmission in a same PRACH repetition cycle and/or a same PRACH configuration period (e.g., a time interval allocated and/or indicated by a network node for initial first message transmissions). Alternatively, or additionally, the first transmission and the second transmission are not retransmissions of a PRACH preamble (e.g., a retransmission by the UE based at least in part on a first message failure).

In some aspects, a network node may receive a first transmission including a PRACH preamble and a second transmission including the same PRACH preamble. Based at least in part on receiving multiple PRACH transmissions with a same PRACH preamble, the network node may transmit a response message (e.g., a network node response message), and the response message may include a first timing advance associated with the first transmission, and a second timing advance associated with the second transmission. Alternatively, or additionally, the response message may include the PRACH preamble included in the first transmission and the second transmission.

Particular aspects of the subject matter described in this disclosure can be implemented to realize one or more of the following potential advantages. In some examples, by generating and transmitting multiple PRACH preamble transmissions in a same PRACH repetition cycle and/or PRACH configuration period, the described techniques can be used to enable a UE to mitigate failure in accessing a wireless network and/or mitigate increasing a latency in accessing the wireless network. To illustrate, a first transmission from a first UE may be part of a first PRACH collision with a transmission from a second UE based at least in part on both UEs selecting a same PRACH preamble. The probability of the second transmission from the first UE being part of a second PRACH collision with another transmission from the second UE and/or a third UE is lower, resulting in an increased probability that at least one of the two transmissions is received by a network node successfully and/or without a collision. Accordingly, generating and transmitting at least two transmissions with different PRACH preambles in a same PRACH repetition cycle may mitigate the UE failing to access the wireless network and/or may reduce a latency in the UE accessing the wireless network.

Multiple-access radio access technologies (RATs) have been adopted in various telecommunication standards to provide common protocols that enable wireless communication devices to communicate on a municipal, enterprise, national, regional, or global level. For example, 5G New Radio (NR) is part of a continuous mobile broadband evolution promulgated by the Third Generation Partnership Project (3GPP). 5G NR supports various technologies and use cases including enhanced mobile broadband (cMBB), ultra-reliable low-latency communication (URLLC), massive machine-type communication (mMTC), millimeter wave (mmWave) technology, beamforming, network slicing, edge computing, Internet of Things (IoT) connectivity and management, and network function virtualization (NFV).

As the demand for broadband access increases and as technologies supported by wireless communication networks evolve, further technological improvements may be adopted in or implemented for 5G NR or future RATs, such as 6G, to further advance the evolution of wireless communication for a wide variety of existing and new use cases and applications. Such technological improvements may be associated with new frequency band expansion, licensed and unlicensed spectrum access, overlapping spectrum use, small cell deployments, non-terrestrial network (NTN) deployments, disaggregated network architectures and network topology expansion, device aggregation, advanced duplex communication, sidelink and other device-to-device direct communication, IoT (including passive or ambient IoT) networks, reduced capability (RedCap) UE functionality, industrial connectivity, multiple-subscriber implementations, high-precision positioning, radio frequency (RF) sensing, and/or artificial intelligence or machine learning (AI/ML), among other examples. These technological improvements may support use cases such as wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples. The methods, operations, apparatuses, and techniques described herein may enable one or more of the foregoing technologies and/or support one or more of the foregoing use cases.

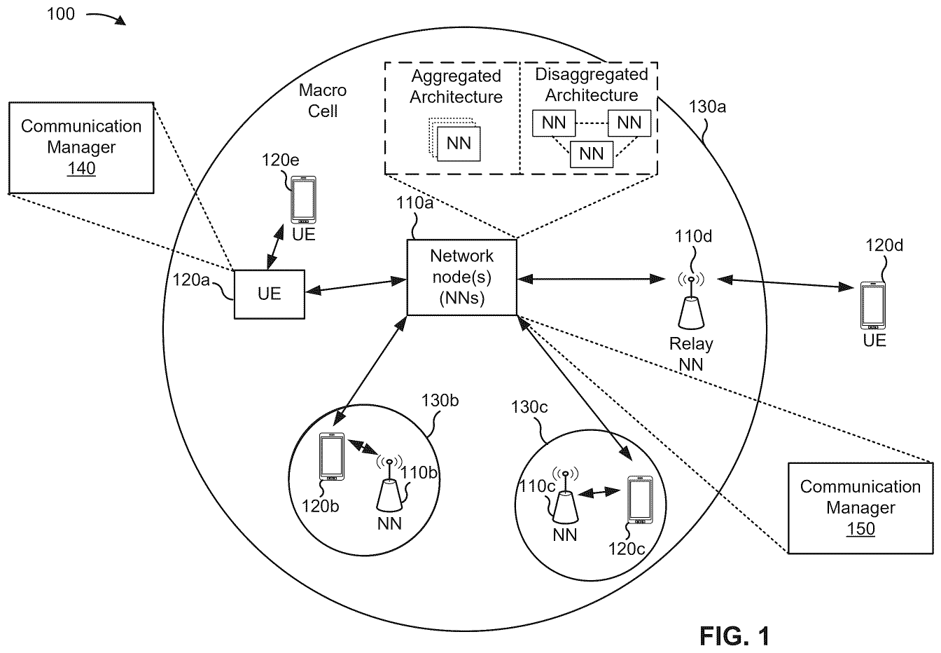

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110, shown as a network node (NN) 110a, a network node 110b, a network node 110c, and a network node 110d. The network nodes 110 may support communications with multiple UEs 120, shown as a UE 120a, a UE 120b, a UE 120c, a UE 120d, and a UE 120c.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency ranges. Examples of RATs include a 4G RAT, a 5G/NR RAT, and/or a 6G RAT, among other examples. In some examples, when multiple RATs are deployed in a given geographic area, each RAT in the geographic area may operate on different frequencies to avoid interference with one another.

Various operating bands have been defined as frequency range designations FR1 (410 MHz through 7.125 GHZ), FR2 (24.25 GHz through 52.6 GHZ), FR3 (7.125 GHz through 24.25 GHZ), FR4a or FR4-1 (52.6 GHz through 71 GHZ), FR4 (52.6 GHZ through 114.25 GHZ), and FR5 (114.25 GHz through 300 GHz). Although a portion of FR1 is greater than 6 GHZ, FR1 is often referred to (interchangeably) as a “Sub-6 GHz” band in some documents and articles. Similarly, FR2 is often referred to (interchangeably) as a “millimeter wave” band in some documents and articles, despite being different than the extremely high frequency (EHF) band (30 GHz through 300 GH2), which is identified by the International Telecommunications Union (ITU) as a “millimeter wave” band. The frequencies between FR1 and FR2 are often referred to as mid-band frequencies, which include FR3. Frequency bands falling within FR.3 may inherit FR1 characteristics or FR2 characteristics, and thus may effectively extend features of FR1 or FR2 into mid-band frequencies. Thus, “sub-6 GHz,” if used herein, may broadly refer to frequencies that are less than 6 GHZ, that are within FR1, and/or that are included in mid-band frequencies. Similarly, the term “millimeter wave,” if used herein, may broadly refer to frequencies that are included in mid-band frequencies, that are within FR2, FR4, FR4-a or FR4-1, or FR5, and/or that are within the EHF band. Higher frequency bands may extend 5G NR operation, 6G operation, and/or other RATs beyond 52.6 GHz. For example, each of FR4a, FR4-1, FR4, and FR5 falls within the EHF band. In some examples, the wireless communication network 100 may implement dynamic spectrum sharing (DSS), in which multiple RATs (for example, 4G/Long Term Evolution (LTE) and 5G/NR) are implemented with dynamic bandwidth allocation (for example, based on user demand) in a single frequency band. It is contemplated that the frequencies included in these operating bands (for example, FR1, FR2, FR3, FR4, FR4-a, FR4-1, and/or FR5) may be modified, and techniques described herein may be applicable to those modified frequency ranges.

A network node 110 may include one or more devices, components, or systems that enable communication between a UE 120 and one or more devices, components, or systems of the wireless communication network 100. A network node 110 may be, may include, or may also be referred to as an NR network node, a 5G network node, a 6G network node, a Node B, an eNB, a gNB, an access point (AP), a transmission reception point (TRP), a mobility element, a core, a network entity, a network element, a network equipment, and/or another type of device, component, or system included in a radio access network (RAN).

A network node 110 may be implemented as a single physical node (for example, a single physical structure) or may be implemented as two or more physical nodes (for example, two or more distinct physical structures). For example, a network node 110 may be a device or system that implements part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node (having an aggregated architecture), meaning that the network node 110 may implement a full radio protocol stack that is physically and logically integrated within a single node (for example, a single physical structure) in the wireless communication network 100. For example, an aggregated network node 110 may consist of a single standalone base station or a single TRP that uses a full radio protocol stack to enable or facilitate communication between a UE 120 and a core network of the wireless communication network 100.

Alternatively, and as also shown, a network node 110 may be a disaggregated network node (sometimes referred to as a disaggregated base station), meaning that the network node 110 may implement a radio protocol stack that is physically distributed and/or logically distributed among two or more nodes in the same geographic location or in different geographic locations. For example, a disaggregated network node may have a disaggregated architecture. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating base station functionality into multiple units that can be individually deployed.

The network nodes 110 of the wireless communication network 100 may include one or more central units (CUs), one or more distributed units (DUs), and/or one or more radio units (RUs). A CU may host one or more higher layer control functions, such as radio resource control (RRC) functions, packet data convergence protocol (PDCP) functions, and/or service data adaptation protocol (SDAP) functions, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host one or more lower PHY layer functions, such as a fast Fourier transform (FFT), an inverse FFT (IFFT), beamforming, PRACH extraction and filtering, and/or scheduling of resources for one or more UEs 120, among other examples. An RU may host RF processing functions or lower PHY layer functions, such as an FFT, an iFFT, beamforming, or PRACH extraction and filtering, among other examples, according to a functional split, such as a lower layer functional split. In such an architecture, each RU can be operated to handle over the air (OTA) communication with one or more UEs 120.

In some aspects, a single network node 110 may include a combination of one or more CUs, one or more DUs, and/or one or more RUs. Additionally or alternatively, a network node 110 may include one or more Near-Real Time (Near-RT) RAN Intelligent Controllers (RICs) and/or one or more Non-Real Time (Non-RT) RICs. In some examples, a CU, a DU, and/or an RU may be implemented as a virtual unit, such as a virtual central unit (VCU), a virtual distributed unit (VDU), or a virtual radio unit (VRU), among other examples. A virtual unit may be implemented as a virtual network function, such as associated with a cloud deployment.

Some network nodes 110 (for example, a base station, an RU, or a TRP) may provide communication coverage for a particular geographic area. In the 3GPP, the term “cell” can refer to a coverage area of a network node 110 or to a network node 110 itself, depending on the context in which the term is used. A network node 110 may support one or multiple (for example, three) cells. In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In some examples, a cell may not necessarily be stationary. For example, the geographic area of the cell may move according to the location of an associated mobile network node 110 (for example, a train, a satellite base station, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. In the example shown in FIG. 1, the network node 110a may be a macro network node for a macro cell 130a, the network node 110b may be a pico network node for a pico cell 130b, and the network node 110c may be a femto network node for a femto cell 130c. Various different types of network nodes 110 may generally transmit at different power levels, serve different coverage areas, and/or have different impacts on interference in the wireless communication network 100 than other types of network nodes 110. For example, macro network nodes may have a high transmit power level (for example, 5 to 40 watts), whereas pico network nodes, femto network nodes, and relay network nodes may have lower transmit power levels (for example, 0.1 to 2 watts).

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink channels may include one or more control channels and one or more data channels. A downlink control channel may be used to transmit downlink control information (DCI) (for example, scheduling information, reference signals, and/or configuration information) from a network node 110 to a UE 120. A downlink data channel may be used to transmit downlink data (for example, user data associated with a UE 120) from a network node 110 to a UE 120. Downlink control channels may include one or more physical downlink control channels (PDCCHs), and downlink data channels may include one or more physical downlink shared channels (PDSCHs). Uplink channels may similarly include one or more control channels and one or more data channels. An uplink control channel may be used to transmit uplink control information (UCI) (for example, reference signals and/or feedback corresponding to one or more downlink transmissions) from a UE 120 to a network node 110. An uplink data channel may be used to transmit uplink data (for example, user data associated with a UE 120) from a UE 120 to a network node 110. Uplink control channels may include one or more physical uplink control channels (PUCCHs), and uplink data channels may include one or more physical uplink shared channels (PUSCHs). The downlink and the uplink May each include a set of resources on which the network node 110 and the UE 120 may communicate.

Downlink and uplink resources may include time domain resources (frames, subframes, slots, and/or symbols), frequency domain resources (frequency bands, component carriers, subcarriers, resource blocks, and/or resource elements), and/or spatial domain resources (particular transmit directions and/or beam parameters). Frequency domain resources of some bands may be subdivided into bandwidth parts (BWPs). A BWP may be a continuous block of frequency domain resources (for example, a continuous block of resource blocks) that are allocated for one or more UEs 120. A UE 120 may be configured with both an uplink BWP and a downlink BWP (where the uplink BWP and the downlink BWP may be the same BWP or different BWPs). A BWP may be dynamically configured (for example, by a network node 110 transmitting a DCI configuration to the one or more UEs 120) and/or reconfigured, which means that a BWP can be adjusted in real-time (or near-real-time) based on changing network conditions in the wireless communication network 100 and/or based on the specific requirements of the one or more UEs 120. This enables more efficient use of the available frequency domain resources in the wireless communication network 100 because fewer frequency domain resources may be allocated to a BWP for a UE 120 (which may reduce the quantity of frequency domain resources that a UE 120 is required to monitor), leaving more frequency domain resources to be spread across multiple UEs 120. Thus, BWPs may also assist in the implementation of lower-capability UEs 120 by facilitating the configuration of smaller bandwidths for communication by such UEs 120.

As described above, in some aspects, the wireless communication network 100 may be, may include, or may be included in, an IAB network. In an IAB network, at least one network node 110 is an anchor network node that communicates with a core network. An anchor network node 110 may also be referred to as an IAB donor (or “IAB-donor”). The anchor network node 110 may connect to the core network via a wired backhaul link. For example, an Ng interface of the anchor network node 110 may terminate at the core network. Additionally or alternatively, an anchor network node 110 may connect to one or more devices of the core network that provide a core access and mobility management function (AMF). An IAB network also generally includes multiple non-anchor network nodes 110, which may also be referred to as relay network nodes or simply as IAB nodes (or “IAB-nodes”). Each non-anchor network node 110 may communicate directly with the anchor network node 110 via a wireless backhaul link to access the core network, or may communicate indirectly with the anchor network node 110 via one or more other non-anchor network nodes 110 and associated wireless backhaul links that form a backhaul path to the core network. Some anchor network node 110 or other non-anchor network node 110 may also communicate directly with one or more UEs 120 via wireless access links that carry access traffic. In some examples, network resources for wireless communication (such as time resources, frequency resources, and/or spatial resources) may be shared between access links and backhaul links.

In some examples, any network node 110 that relays communications may be referred to as a relay network node, a relay station, or simply as a relay. A relay may receive a transmission of a communication from an upstream station (for example, another network node 110 or a UE 120) and transmit the communication to a downstream station (for example, a UE 120 or another network node 110). In this case, the wireless communication network 100 may include or be referred to as a “multi-hop network.” In the example shown in FIG. 1, the network node 110d (for example, a relay network node) may communicate with the network node 110a (for example, a macro network node) and the UE 120d in order to facilitate communication between the network node 110a and the UE 120d. Additionally or alternatively, a UE 120 may be or may operate as a relay station that can relay transmissions to or from other UEs 120. A UE 120 that relays communications may be referred to as a UE relay or a relay UE, among other examples.

The UEs 120 may be physically dispersed throughout the wireless communication network 100, and each UE 120 may be stationary or mobile. A UE 120 may be, may include, or may be included in an access terminal, another terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, and/or smart jewelry, such as a smart ring or a smart bracelet), an entertainment device (for example, a music device, a video device, and/or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

A UE 120 and/or a network node 110 may include one or more chips, system-on-chips (SoCs), chipsets, packages, or devices that individually or collectively constitute or comprise a processing system. The processing system includes processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions.

The processing system may further include memory circuitry in the form of one or more memory devices, memory blocks, memory elements or other discrete gate or transistor logic or circuitry, each of which may include tangible storage media such as random-access memory or read-only memory (ROM), or combinations thereof (all of which may be generally referred to herein individually as “memories” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code (such as software) that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, Institute of Electrical and Electronics Engineers (IEEE) compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains or transceivers. The UE 120 may include or may be included in a housing that houses components associated with the UE 120 including the processing system.

Some UEs 120 may be considered machine-type communication (MTC) UEs, evolved or enhanced machine-type communication (eMTC), UEs, further enhanced eMTC (feMTC) UEs, or enhanced feMTC (efeMTC) UEs, or further evolutions thereof, all of which may be simply referred to as “MTC UEs”. An MTC UE may be, may include, or may be included in or coupled with a robot, an uncrewed aerial vehicle, a remote device, a sensor, a meter, a monitor, and/or a location tag. Some UEs 120 may be considered IoT devices and/or may be implemented as NB-IoT (narrowband IoT) devices. An IoT UE or NB-IoT device may be, may include, or may be included in or coupled with an industrial machine, an appliance, a refrigerator, a doorbell camera device, a home automation device, and/or a light fixture, among other examples. Some UEs 120 may be considered Customer Premises Equipment, which may include telecommunications devices that are installed at a customer location (such as a home or office) to enable access to a service provider's network (such as included in or in communication with the wireless communication network 100).

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between UEs 120 of the first category and UEs 120 of the second capability). A UE 120 of the third category may be referred to as a reduced capacity UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, and/or cameras that are associated with a limited bandwidth, power capacity, and/or transmission range, among other examples. RedCap UEs may support healthcare environments, building automation, electrical distribution, process automation, transport and logistics, and/or smart city deployments, among other examples.

In some examples, two or more UEs 120 (for example, shown as UE 120a and UE 120c) may communicate directly with one another using sidelink communications (for example, without communicating by way of a network node 110 as an intermediary). As an example, the UE 120a may directly transmit data, control information, or other signaling as a sidelink communication to the UE 120c. This is in contrast to, for example, the UE 120a first transmitting data in an UL communication to a network node 110, which then transmits the data to the UE 120e in a DL communication. In various examples, the UEs 120 may transmit and receive sidelink communications using peer-to-peer (P2P) communication protocols, device-to-device (D2D) communication protocols, vehicle-to-everything (V2X) communication protocols (which may include vehicle-to-vehicle (V2V) protocols, vehicle-to-infrastructure (V2I) protocols, and/or vehicle-to-pedestrian (V2P) protocols), and/or mesh network communication protocols. In some deployments and configurations, a network node 110 may schedule and/or allocate resources for sidelink communications between UEs 120 in the wireless communication network 100. In some other deployments and configurations, a UE 120 (instead of a network node 110) may perform, or collaborate or negotiate with one or more other UEs to perform, scheduling operations, resource selection operations, and/or other operations for sidelink communications.

In various examples, some of the network nodes 110 and the UEs 120 of the wireless communication network 100 may be configured for full-duplex operation in addition to half-duplex operation. A network node 110 or a UE 120 operating in a half-duplex mode may perform only one of transmission or reception during particular time resources, such as during particular slots, symbols, or other time periods. Half-duplex operation may involve time-division duplexing (TDD), in which DL transmissions of the network node 110 and UL transmissions of the UE 120 do not occur in the same time resources (that is, the transmissions do not overlap in time). In contrast, a network node 110 or a UE 120 operating in a full-duplex mode can transmit and receive communications concurrently (for example, in the same time resources). By operating in a full-duplex mode, network nodes 110 and/or UEs 120 may generally increase the capacity of the network and the radio access link. In some examples, full-duplex operation may involve frequency-division duplexing (FDD), in which DL transmissions of the network node 110 are performed in a first frequency band or on a first component carrier and transmissions of the UE 120 are performed in a second frequency band or on a second component carrier different than the first frequency band or the first component carrier, respectively. In some examples, full-duplex operation may be enabled for a UE 120 but not for a network node 110. For example, a UE 120 may simultaneously transmit an UL transmission to a first network node 110 and receive a DL transmission from a second network node 110 in the same time resources. In some other examples, full-duplex operation may be enabled for a network node 110 but not for a UE 120. For example, a network node 110 may simultaneously transmit a DL transmission to a first UE 120 and receive an UL transmission from a second UE 120 in the same time resources. In some other examples, full-duplex operation may be enabled for both a network node 110 and a UE 120.

In some examples, the UEs 120 and the network nodes 110 may perform MIMO communication. “MIMO” generally refers to transmitting or receiving multiple signals (such as multiple layers or multiple data streams) simultaneously over the same time and frequency resources. MIMO techniques generally exploit multipath propagation. MIMO may be implemented using various spatial processing or spatial multiplexing operations. In some examples, MIMO may support simultaneous transmission to multiple receivers, referred to as multi-user MIMO (MU-MIMO). Some RATs may employ advanced MIMO techniques, such as mTRP operation (including redundant transmission or reception on multiple TRPs), reciprocity in the time domain or the frequency domain, single-frequency-network (SFN) transmission, or non-coherent joint transmission (NC-JT).

In some aspects, a UE (e.g., a UE 120) may include a communication manager 140. As described in more detail elsewhere herein, the communication manager 140 may receive system information associated with a network node, the system information indicating multiple PRACH preambles to use for a RACH procedure with the network node; and transmit, as part of the RACH procedure with the network node, a first transmission comprising a first PRACH preamble of the multiple PRACH preambles and a second transmission comprising a second PRACH preamble of the multiple PRACH preambles. Additionally, or alternatively, the communication manager 140 may perform one or more other operations described herein.

In some aspects, a network node (e.g., a network node 110) may include a communication manager 150. As described in more detail elsewhere herein, the communication manager 150 may receive a first transmission comprising a PRACH preamble and a second transmission comprising the PRACH preamble; and transmit a response message associated with the PRACH preamble, the response message comprising: a first timing advance associated with the first transmission, and a second timing advance associated with the second transmission. Additionally, or alternatively, the communication manager 150 may perform one or more other operations described herein.

As indicated above, FIG. 1 is provided as an example. Other examples may differ from what is described with regard to FIG. 1.

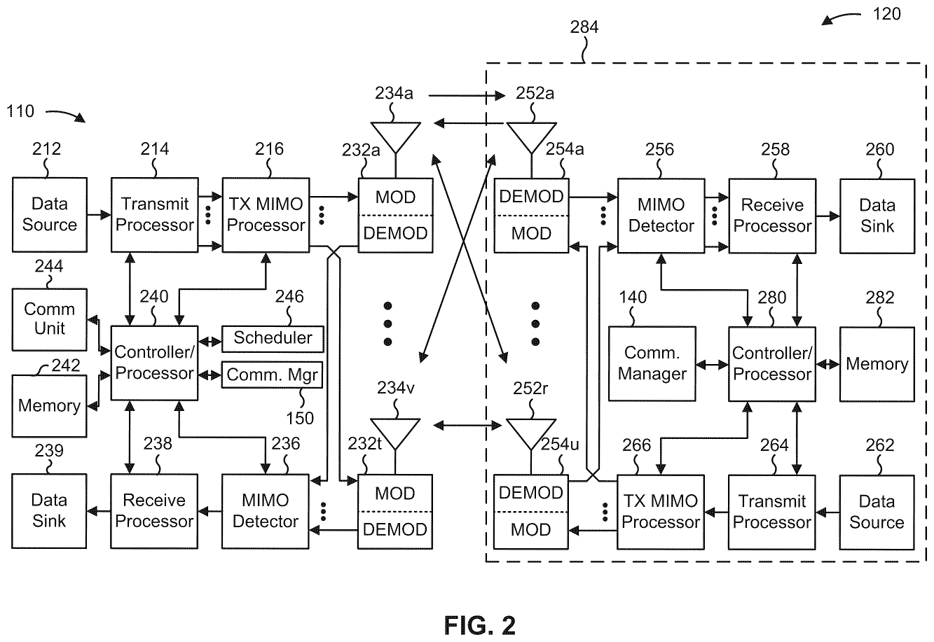

FIG. 2 is a diagram illustrating an example network node 110 in communication with an example UE 120 in a wireless network, in accordance with the present disclosure.

As shown in FIG. 2, the network node 110 may include a data source 212, a transmit processor 214, a transmit (TX) MIMO processor 216, a set of modems 232 (shown as 232a through 232t, where t≥1), a set of antennas 234 (shown as 234a through 234v, where v≥1), a MIMO detector 236, a receive processor 238, a data sink 239, a controller/processor 240, a memory 242, a communication unit 244, a scheduler 246, and/or a communication manager 150, among other examples. In some configurations, one or a combination of the antenna(s) 234, the modem(s) 232, the MIMO detector 236, the receive processor 238, the transmit processor 214, and/or the TX MIMO processor 216 may be included in a transceiver of the network node 110. The transceiver may be under control of and used by one or more processors, such as the controller/processor 240, and in some aspects in conjunction with processor-readable code stored in the memory 242, to perform aspects of the methods, processes, and/or operations described herein. In some aspects, the network node 110 may include one or more interfaces, communication components, and/or other components that facilitate communication with the UE 120 or another network node.

The terms “processor,” “controller,” or “controller/processor” may refer to one or more controllers and/or one or more processors. For example, reference to “a/the processor,” “a/the controller/processor,” or the like (in the singular) should be understood to refer to any one or more of the processors described in connection with FIG. 2, such as a single processor or a combination of multiple different processors. Reference to “one or more processors” should be understood to refer to any one or more of the processors described in connection with FIG. 2. For example, one or more processors of the network node 110 may include transmit processor 214, TX MIMO processor 216, MIMO detector 236, receive processor 238, and/or controller/processor 240. Similarly, one or more processors of the UE 120 may include MIMO detector 256, receive processor 258, transmit processor 264, TX MIMO processor 266, and/or controller/processor 280.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” should be understood to refer to any one or more memories of a corresponding device, such as the memory described in connection with FIG. 2. For example, operation described as being performed by one or more memories can be performed by the same subset of the one or more memories or different subsets of the one or more memories.

For downlink communication from the network node 110 to the UE 120, the transmit processor 214 may receive data (“downlink data”) intended for the UE 120 (or a set of UEs that includes the UE 120) from the data source 212 (such as a data pipeline or a data queue). In some examples, the transmit processor 214 may select one or more MCSs for the UE 120 in accordance with one or more channel quality indicators (CQIs) received from the UE 120. The network node 110 may process the data (for example, including encoding the data) for transmission to the UE 120 on a downlink in accordance with the MCS(s) selected for the UE 120 to generate data symbols. The transmit processor 214 may process system information (for example, semi-static resource partitioning information (SRPI)) and/or control information (for example, CQI requests, grants, and/or upper layer signaling) and provide overhead symbols and/or control symbols. The transmit processor 214 may generate reference symbols for reference signals (for example, a cell-specific reference signal (CRS), a demodulation reference signal (DMRS), or a channel state information (CSI) reference signal (CSI-RS)) and/or synchronization signals (for example, a primary synchronization signal (PSS) or a secondary synchronization signals (SSS)).

The TX MIMO processor 216 may perform spatial processing (for example, precoding) on the data symbols, the control symbols, the overhead symbols, and/or the reference symbols, if applicable, and may provide a set of output symbol streams (for example, T output symbol streams) to the set of modems 232. For example, each output symbol stream may be provided to a respective modulator component (shown as MOD) of a modem 232. Each modem 232 may use the respective modulator component to process (for example, to modulate) a respective output symbol stream (for example, for orthogonal frequency division multiplexing (OFDM)) to obtain an output sample stream. Each modem 232 may further use the respective modulator component to process (for example, convert to analog, amplify, filter, and/or upconvert) the output sample stream to obtain a time domain downlink signal. The modems 232a through 232t may together transmit a set of downlink signals (for example, T downlink signals) via the corresponding set of antennas 234.

A downlink signal may include a DCI communication, a MAC control element (MAC-CE) communication, an RRC communication, a downlink reference signal, or another type of downlink communication. Downlink signals may be transmitted on a PDCCH, a PDSCH, and/or on another downlink channel. A downlink signal may carry one or more transport blocks (TBs) of data. A TB may be a unit of data that is transmitted over an air interface in the wireless communication network 100. A data stream (for example, from the data source 212) may be encoded into multiple TBs for transmission over the air interface. The quantity of TBs used to carry the data associated with a particular data stream may be associated with a TB size common to the multiple TBs. The TB size may be based on or otherwise associated with radio channel conditions of the air interface, the MCS used for encoding the data, the downlink resources allocated for transmitting the data, and/or another parameter. In general, the larger the TB size, the greater the amount of data that can be transmitted in a single transmission, which reduces signaling overhead. However, larger TB sizes may be more prone to transmission and/or reception errors than smaller TB sizes, but such errors may be mitigated by more robust error correction techniques.

For uplink communication from the UE 120 to the network node 110, uplink signals from the UE 120 may be received by an antenna 234, may be processed by a modem 232 (for example, a demodulator component, shown as DEMOD, of a modem 232), may be detected by the MIMO detector 236 (for example, a receive (Rx) MIMO processor) if applicable, and/or may be further processed by the receive processor 238 to obtain decoded data and/or control information. The receive processor 238 may provide the decoded data to a data sink 239 (which may be a data pipeline, a data queue, and/or another type of data sink) and provide the decoded control information to a processor, such as the controller/processor 240.

The network node 110 may use the scheduler 246 to schedule one or more UEs 120 for downlink or uplink communications. In some aspects, the scheduler 246 may use DCI to dynamically schedule DL transmissions to the UE 120 and/or UL transmissions from the UE 120. In some examples, the scheduler 246 may allocate recurring time domain resources and/or frequency domain resources that the UE 120 may use to transmit and/or receive communications using an RRC configuration (for example, a semi-static configuration), for example, to perform semi-persistent scheduling (SPS) or to configure a configured grant (CG) for the UE 120.

One or more of the transmit processor 214, the TX MIMO processor 216, the modem 232, the antenna 234, the MIMO detector 236, the receive processor 238, and/or the controller/processor 240 may be included in an RF chain of the network node 110. An RF chain may include one or more filters, mixers, oscillators, amplifiers, analog-to-digital converters (ADCs), and/or other devices that convert between an analog signal (such as for transmission or reception via an air interface) and a digital signal (such as for processing by one or more processors of the network node 110). In some aspects, the RF chain may be or may be included in a transceiver of the network node 110.

In some examples, the network node 110 may use the communication unit 244 to communicate with a core network and/or with other network nodes. The communication unit 244 may support wired and/or wireless communication protocols and/or connections, such as Ethernet, optical fiber, common public radio interface (CPRI), and/or a wired or wireless backhaul, among other examples. The network node 110 may use the communication unit 244 to transmit and/or receive data associated with the UE 120 or to perform network control signaling, among other examples. The communication unit 244 may include a transceiver and/or an interface, such as a network interface.

The UE 120 may include a set of antennas 252 (shown as antennas 252a through 252r, where r≥1), a set of modems 254 (shown as modems 254a through 254u, where u≥1), a MIMO detector 256, a receive processor 258, a data sink 260, a data source 262, a transmit processor 264, a TX MIMO processor 266, a controller/processor 280, a memory 282, and/or a communication manager 140, among other examples. One or more of the components of the UE 120 may be included in a housing 284. In some aspects, one or a combination of the antenna(s) 252, the modem(s) 254, the MIMO detector 256, the receive processor 258, the transmit processor 264, or the TX MIMO processor 266 may be included in a transceiver that is included in the UE 120. The transceiver may be under control of and used by one or more processors, such as the controller/processor 280, and in some aspects in conjunction with processor-readable code stored in the memory 282, to perform aspects of the methods, processes, or operations described herein. In some aspects, the UE 120 may include another interface, another communication component, and/or another component that facilitates communication with the network node 110 and/or another UE 120.

For downlink communication from the network node 110 to the UE 120, the set of antennas 252 may receive the downlink communications or signals from the network node 110 and may provide a set of received downlink signals (for example, R received signals) to the set of modems 254. For example, each received signal may be provided to a respective demodulator component (shown as DEMOD) of a modem 254. Each modem 254 may use the respective demodulator component to condition (for example, filter, amplify, downconvert, and/or digitize) a received signal to obtain input samples. Each modem 254 may use the respective demodulator component to further demodulate or process the input samples (for example, for OFDM) to obtain received symbols. The MIMO detector 256 may obtain received symbols from the set of modems 254, may perform MIMO detection on the received symbols if applicable, and may provide detected symbols. The receive processor 258 may process (for example, decode) the detected symbols, may provide decoded data for the UE 120 to the data sink 260 (which may include a data pipeline, a data queue, and/or an application executed on the UE 120), and may provide decoded control information and system information to the controller/processor 280.

For uplink communication from the UE 120 to the network node 110, the transmit processor 264 may receive and process data (“uplink data”) from a data source 262 (such as a data pipeline, a data queue, and/or an application executed on the UE 120) and control information from the controller/processor 280. The control information may include one or more parameters, feedback, one or more signal measurements, and/or other types of control information. In some aspects, the receive processor 258 and/or the controller/processor 280 may determine, for a received signal (such as received from the network node 110 or another UE), one or more parameters relating to transmission of the uplink communication. The one or more parameters may include a reference signal received power (RSRP) parameter, a received signal strength indicator (RSSI) parameter, a reference signal received quality (RSRQ) parameter, a CQI parameter, or a transmit power control (TPC) parameter, among other examples. The control information may include an indication of the RSRP parameter, the RSSI parameter, the RSRQ parameter, the CQI parameter, the TPC parameter, and/or another parameter. The control information may facilitate parameter selection and/or scheduling for the UE 120 by the network node 110.

The transmit processor 264 may generate reference symbols for one or more reference signals, such as an uplink DMRS, an uplink sounding reference signal (SRS), and/or another type of reference signal. The symbols from the transmit processor 264 may be precoded by the TX MIMO processor 266, if applicable, and further processed by the set of modems 254 (for example, for DFT-s-OFDM or CP-OFDM). The TX MIMO processor 266 may perform spatial processing (for example, precoding) on the data symbols, the control symbols, the overhead symbols, and/or the reference symbols, if applicable, and may provide a set of output symbol streams (for example, U output symbol streams) to the set of modems 254. For example, each output symbol stream may be provided to a respective modulator component (shown as MOD) of a modem 254. Each modem 254 may use the respective modulator component to process (for example, to modulate) a respective output symbol stream (for example, for OFDM) to obtain an output sample stream. Each modem 254 may further use the respective modulator component to process (for example, convert to analog, amplify, filter, and/or upconvert) the output sample stream to obtain an uplink signal.

The modems 254a through 254u may transmit a set of uplink signals (for example, R uplink signals or U uplink symbols) via the corresponding set of antennas 252. An uplink signal may include a UCI communication, a MAC-CE communication, an RRC communication, or another type of uplink communication. Uplink signals may be transmitted on a PUSCH, a PUCCH, and/or another type of uplink channel. An uplink signal may carry one or more TBs of data. Sidelink data and control transmissions (that is, transmissions directly between two or more UEs 120) may generally use similar techniques as were described for uplink data and control transmission, and may use sidelink-specific channels such as a physical sidelink shared channel (PSSCH), a physical sidelink control channel (PSCCH), and/or a physical sidelink feedback channel (PSFCH).

One or more antennas of the set of antennas 252 or the set of antennas 234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. As used herein, “antenna” can refer to one or more antennas, one or more antenna panels, one or more antenna groups, one or more sets of antenna elements, or one or more antenna arrays. “Antenna panel” can refer to a group of antennas (such as antenna elements) arranged in an array or panel, which may facilitate beamforming by manipulating parameters of the group of antennas. “Antenna module” may refer to circuitry including one or more antennas, which may also include one or more other components (such as filters, amplifiers, or processors) associated with integrating the antenna module into a wireless communication device.

In some examples, each of the antenna elements of an antenna 234 or an antenna 252 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range.

The amplitudes and/or phases of signals transmitted via antenna elements and/or sub-elements may be modulated and shifted relative to each other (such as by manipulating phase shift, phase offset, and/or amplitude) to generate one or more beams, which is referred to as beamforming. The term “beam” may refer to a directional transmission of a wireless signal toward a receiving device or otherwise in a desired direction. “Beam” may also generally refer to a direction associated with such a directional signal transmission, a set of directional resources associated with the signal transmission (for example, an angle of arrival, a horizontal direction, and/or a vertical direction), and/or a set of parameters that indicate one or more aspects of a directional signal, a direction associated with the signal, and/or a set of directional resources associated with the signal. In some implementations, antenna elements may be individually selected or deselected for directional transmission of a signal (or signals) by controlling amplitudes of one or more corresponding amplifiers and/or phases of the signal(s) to form one or more beams. The shape of a beam (such as the amplitude, width, and/or presence of side lobes) and/or the direction of a beam (such as an angle of the beam relative to a surface of an antenna array) can be dynamically controlled by modifying the phase shifts, phase offsets, and/or amplitudes of the multiple signals relative to each other.

Different UEs 120 or network nodes 110 may include different numbers of antenna elements. For example, a UE 120 may include a single antenna element, two antenna elements, four antenna elements, eight antenna elements, or a different number of antenna elements. As another example, a network node 110 may include eight antenna elements, 24 antenna elements, 64 antenna elements, 128 antenna elements, or a different number of antenna elements. Generally, a larger number of antenna elements may provide increased control over parameters for beam generation relative to a smaller number of antenna elements, whereas a smaller number of antenna elements may be less complex to implement and may use less power than a larger number of antenna elements. Multiple antenna elements may support multiple-layer transmission, in which a first layer of a communication (which may include a first data stream) and a second layer of a communication (which may include a second data stream) are transmitted using the same time and frequency resources with spatial multiplexing.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

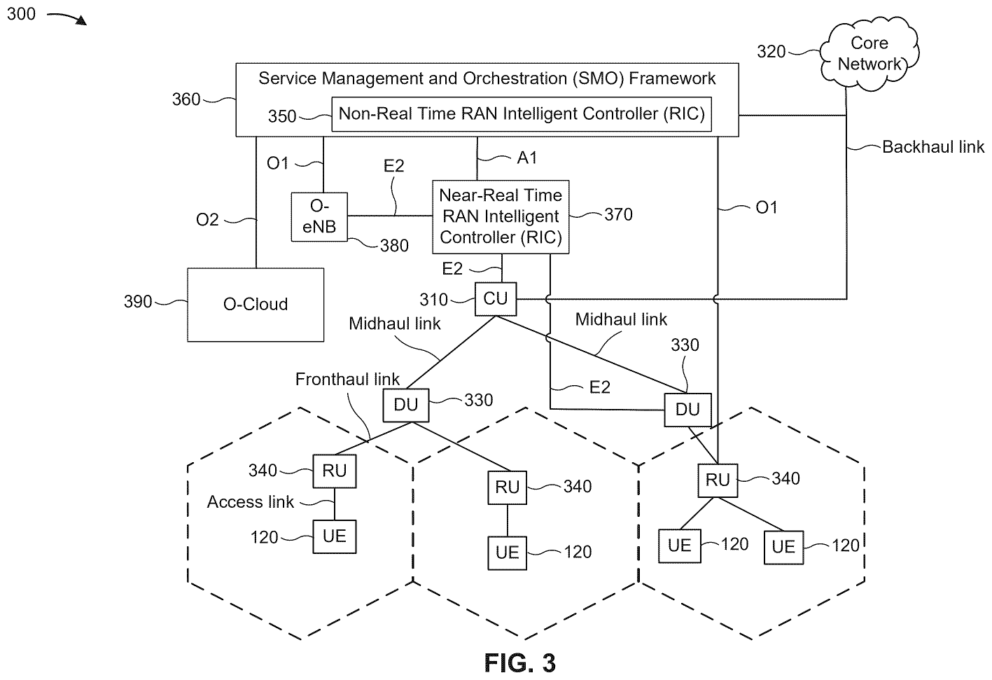

FIG. 3 is a diagram illustrating an example disaggregated base station architecture 300, in accordance with the present disclosure. One or more components of the example disaggregated base station architecture 300 may be, may include, or may be included in one or more network nodes (such one or more network nodes 110). The disaggregated base station architecture 300 may include a CU 310 that can communicate directly with a core network 320 via a backhaul link, or that can communicate indirectly with the core network 320 via one or more disaggregated control units, such as a Non-RT RIC 350 associated with a Service Management and Orchestration (SMO) Framework 360 and/or a Near-RT RIC 370 (for example, via an E2 link). The CU 310 may communicate with one or more DUs 330 via respective midhaul links, such as via F1 interfaces. Each of the DUs 330 may communicate with one or more RUs 340 via respective fronthaul links. Each of the RUs 340 may communicate with one or more UEs 120 via respective RF access links. In some deployments, a UE 120 may be simultaneously served by multiple RUs 340.

Each of the components of the disaggregated base station architecture 300, including the CUs 310, the DUs 330, the RUs 340, the Near-RT RICs 370, the Non-RT RICs 350, and the SMO Framework 360, may include one or more interfaces or may be coupled with one or more interfaces for receiving or transmitting signals, such as data or information, via a wired or wireless transmission medium.

In some aspects, the CU 310 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 310 may be deployed to communicate with one or more DUs 330, as necessary, for network control and signaling. Each DU 330 may correspond to a logical unit that includes one or more base station functions to control the operation of one or more RUs 340. For example, a DU 330 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 330, or for communicating signals with the control functions hosted by the CU 310. Each RU 340 may implement lower layer functionality. In some aspects, real-time and non-real-time aspects of control and user plane communication with the RU(s) 340 may be controlled by the corresponding DU 330.

The SMO Framework 360 may support RAN deployment and provisioning of non-virtualized and virtualized network elements. For non-virtualized network elements, the SMO Framework 360 may support the deployment of dedicated physical resources for RAN coverage requirements, which may be managed via an operations and maintenance interface, such as an O1 interface. For virtualized network elements, the SMO Framework 360 may interact with a cloud computing platform (such as an open cloud (O-Cloud) platform 390) to perform network element life cycle management (such as to instantiate virtualized network elements) via a cloud computing platform interface, such as an O2 interface. A virtualized network element may include, but is not limited to, a CU 310, a DU 330, an RU 340, a non-RT RIC 350, and/or a Near-RT RIC 370. In some aspects, the SMO Framework 360 may communicate with a hardware aspect of a 4G RAN, a 5G NR RAN, and/or a 6G RAN, such as an open eNB (O-cNB) 380, via an O1 interface. Additionally or alternatively, the SMO Framework 360 may communicate directly with each of one or more RUs 340 via a respective O1 interface. In some deployments, this configuration can enable each DU 330 and the CU 310 to be implemented in a cloud-based RAN architecture, such as a vRAN architecture.

The Non-RT RIC 350 may include or may implement a logical function that enables non-real-time control and optimization of RAN elements and resources, AI/ML workflows including model training and updates, and/or policy-based guidance of applications and/or features in the Near-RT RIC 370. The Non-RT RIC 350 may be coupled to or may communicate with (such as via an A1 interface) the Near-RT RIC 370. The Near-RT RIC 370 may include or may implement a logical function that enables near-real-time control and optimization of RAN elements and resources via data collection and actions via an interface (such as via an E2 interface) connecting one or more CUs 310, one or more DUs 330, and/or an O-eNB with the Near-RT RIC 370.

In some aspects, to generate AI/ML models to be deployed in the Near-RT RIC 370, the Non-RT RIC 350 may receive parameters or external enrichment information from external servers. Such information may be utilized by the Near-RT RIC 370 and may be received at the SMO Framework 360 or the Non-RT RIC 350 from non-network data sources or from network functions. In some examples, the Non-RT RIC 350 or the Near-RT RIC 370 may tune RAN behavior or performance. For example, the Non-RT RIC 350 may monitor long-term trends and patterns for performance and may employ AI/ML models to perform corrective actions via the SMO Framework 360 (such as reconfiguration via an O1 interface) or via creation of RAN management policies (such as A1 interface policies).

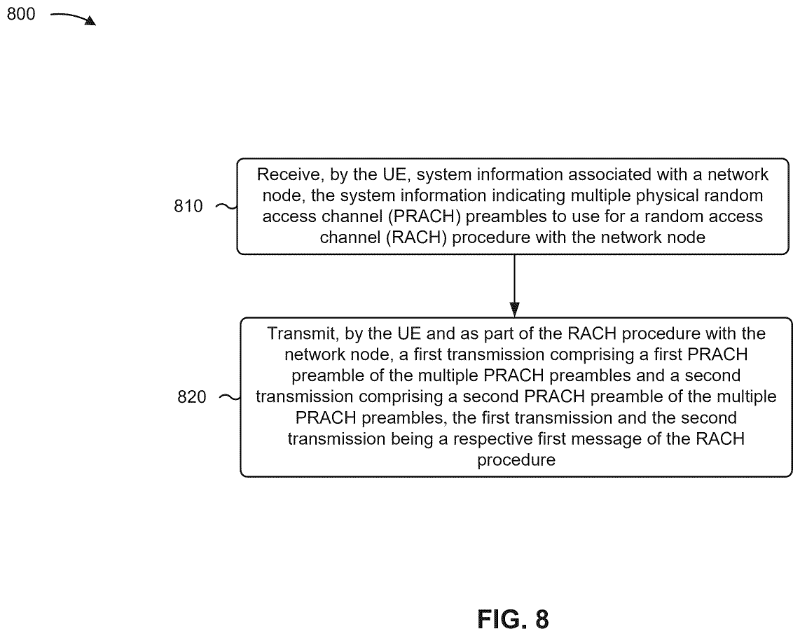

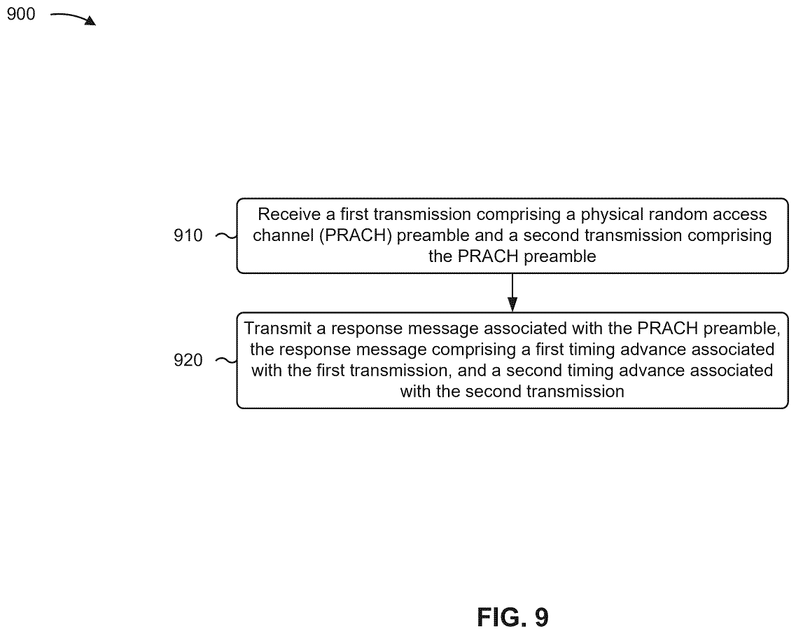

The network node 110, the controller/processor 240 of the network node 110, the UE 120, the controller/processor 280 of the UE 120, the CU 310, the DU 330, the RU 340, or any other component(s) of FIG. 1, 2, or 3 may implement one or more techniques or perform one or more operations associated with multiple PRACH preamble transmissions by a user equipment, as described in more detail elsewhere herein. For example, the controller/processor 240 of the network node 110, the controller/processor 280 of the UE 120, any other component(s) of FIG. 2, the CU 310, the DU 330, or the RU 340 may perform or direct operations of, for example, process 800 of FIG. 8, process 900 of FIG. 9, or other processes as described herein (alone or in conjunction with one or more other processors). The memory 242 may store data and program codes for the network node 110, the network node 110, the CU 310, the DU 330, or the RU 340. The memory 282 may store data and program codes for the UE 120. In some examples, the memory 242 or the memory 282 may include a non-transitory computer-readable medium storing a set of instructions (for example, code or program code) for wireless communication. The memory 242 may include one or more memories, such as a single memory or multiple different memories (of the same type or of different types). The memory 282 may include one or more memories, such as a single memory or multiple different memories (of the same type or of different types). For example, the set of instructions, when executed (for example, directly, or after compiling, converting, or interpreting) by one or more processors of the network node 110, the UE 120, the CU 310, the DU 330, or the RU 340, may cause the one or more processors to perform process 800 of FIG. 8, process 900 of FIG. 9, or other processes as described herein. In some examples, executing instructions may include running the instructions, converting the instructions, compiling the instructions, and/or interpreting the instructions, among other examples.

In some aspects, a UE (e.g., a UE 120) includes means for receiving, by the UE, system information associated with a network node, the system information indicating multiple PRACH preambles to use for a RACH procedure with the network node; and/or means for transmitting, by the UE and as part of the RACH procedure with the network node, a first transmission comprising a first PRACH preamble of the multiple PRACH preambles and a second transmission comprising a second PRACH preamble of the multiple PRACH preambles. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network node (e.g., a network node 110) includes means for receiving a first transmission comprising a PRACH preamble and a second transmission comprising the PRACH preamble; and/or means for transmitting a response message associated with the PRACH preamble, the response message comprising: a first timing advance associated with the first transmission, and a second timing advance associated with the second transmission. The means for the network node to perform operations described herein may include, for example, one or more of communication manager 150, transmit processor 214, TX MIMO processor 216, modem 232, antenna 234, MIMO detector 236, receive processor 238, controller/processor 240, memory 242, or scheduler 246.

As indicated above, FIG. 3 is provided as an example. Other examples may differ from what is described with regard to FIG. 3.

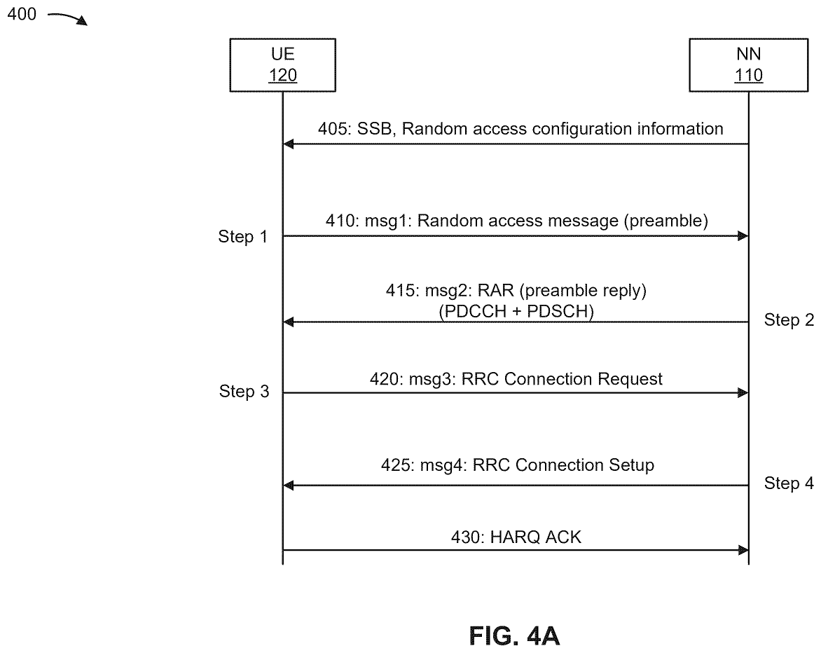

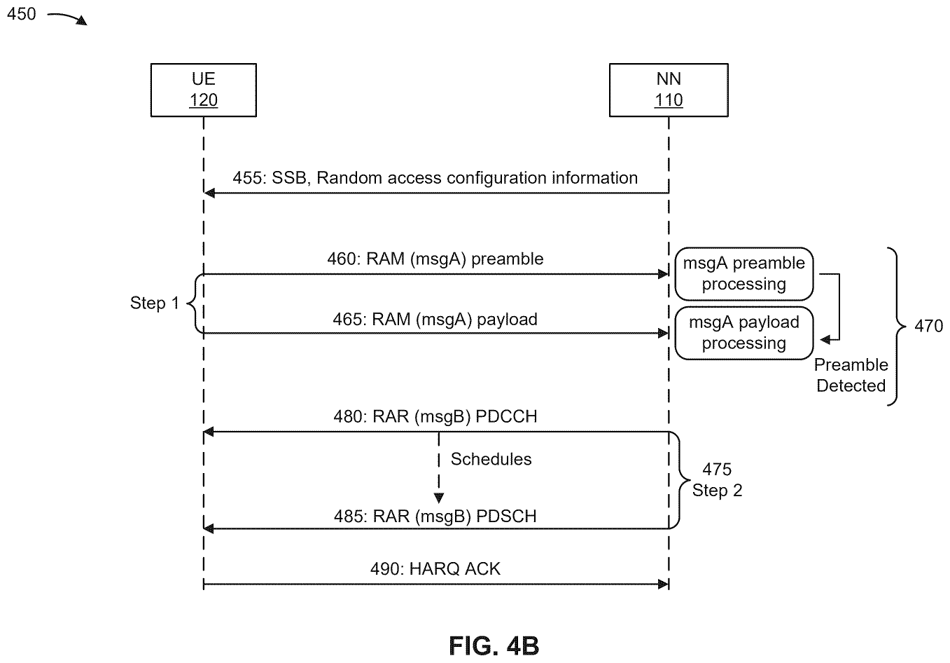

FIGS. 4A and 4B are diagrams illustrating a first example 400 of a four-step random access procedure and a second example 450 of a two-step random access procedure, respectively, in accordance with the present disclosure. As shown in FIGS. 4A and 4B, a network node 110 and a UE 120 may communicate with one another to perform the four-step random access procedure or the two-step random access procedure.

The first example 400 shown by FIG. 4A is an example of a four-step random access procedure. As shown by reference number 405, the network node 110 may transmit, and the UE 120 may receive, one or more SSBs and random access configuration information. In some aspects, the random access configuration information may be transmitted in and/or indicated by system information (e.g., in one or more system information blocks (SIBs)) and/or a synchronization signal block (SSB), such as for contention-based random access. Additionally, or alternatively, the random access configuration information may be transmitted in an RRC message and/or a PDCCH order message that triggers a RACH procedure, such as for contention-free random access. The random access configuration information may include one or more parameters to be used in the random access procedure, such as one or more parameters for transmitting a random access message (RAM) and/or one or more parameters for receiving an RAR.

As shown by reference number 410, the UE 120 may transmit a RAM, which may include a preamble (sometimes referred to as a random access preamble, a PRACH preamble, or a RAM preamble). The message that includes the preamble may be referred to as a message 1, msg1, MSG1, a first message, or an initial message in a four-step random access procedure. The RAM may include a random access preamble identifier.

As shown by reference number 415, the network node 110 may transmit an RAR as a reply to the preamble. The message that includes the RAR may be referred to as message 2, msg2, MSG2, or a second message in a four-step random access procedure. In some aspects, the RAR may indicate the detected random access preamble identifier (e.g., received from the UE 120 in msg1). Additionally, or alternatively, the RAR may indicate a resource allocation (e.g., an uplink grant) to be used by the UE 120 to transmit message 3 (msg3).

In some aspects, as part of the second step of the four-step random access procedure, the network node 110 may transmit a PDCCH communication for the RAR. The PDCCH communication may schedule a PDSCH communication that includes the RAR. For example, the PDCCH communication may indicate a resource allocation for the PDSCH communication. Also as part of the second step of the four-step random access procedure, the network node 110 may transmit the PDSCH communication for the RAR, as scheduled by the PDCCH communication. The RAR may be included in a MAC protocol data unit (PDU) of the PDSCH communication.

As shown by reference number 420, the UE 120 may transmit an RRC connection request message. The RRC connection request message may be referred to as message 3, msg3, MSG3, or a third message of a four-step random access procedure. In some aspects, the RRC connection request may include a UE identifier, UCI, and/or a PUSCH communication (e.g., an RRC connection request).

As shown by reference number 425, the network node 110 may transmit an RRC connection setup message. The RRC connection setup message may be referred to as message 4, msg4, MSG4, or a fourth message of a four-step random access procedure. In some aspects, the RRC connection setup message may include the detected UE identifier, a timing advance value, and/or contention resolution information. As shown by reference number 430, if the UE 120 successfully receives the RRC connection setup message, the UE 120 may transmit a hybrid automatic repeat request (HARQ) acknowledgement (ACK).

The second example 450 shown by FIG. 4B is an example of a two-step random access procedure. As shown by reference number 455, the network node 110 may transmit, and the UE 120 may receive, one or more SSBs and random access configuration information. In some aspects, the random access configuration information may be transmitted in and/or indicated by system information (e.g., in one or more SIBs) and/or an SSB, such as for contention-based random access. Additionally, or alternatively, the random access configuration information may be transmitted in an RRC message and/or a PDCCH order message that triggers a RACH procedure, such as for contention-free random access. The random access configuration information may include one or more parameters to be used in the two-step random access procedure, such as one or more parameters for transmitting a RAM and/or receiving an RAR to the RAM.

As shown by reference number 460, the UE 120 may transmit, and the network node 110 may receive, a RAM preamble. As shown by reference number 465, the UE 120 may transmit, and the network node 110 may receive, a RAM payload. As shown, the UE 120 may transmit the RAM preamble and the RAM payload to the network node 110 as part of an initial (or first) step of the two-step random access procedure. In some aspects, the RAM may be referred to as message A, msgA, a first message, or an initial message in a two-step random access procedure. Furthermore, in some aspects, the RAM preamble may be referred to as a message A preamble, a msgA preamble, a preamble, or a PRACH preamble, and the RAM payload may be referred to as a message A payload, a msgA payload, or a payload. In some aspects, the RAM may include some or all of the contents of message 1 (msg1) and message 3 (msg3) of a four-step random access procedure, which is described in more detail below. For example, the RAM preamble may include some or all contents of message 1 (e.g., a PRACH preamble), and the RAM payload may include some or all contents of message 3 (e.g., a UE identifier, UCI, and/or a PUSCH transmission).

As shown by reference number 470, the network node 110 may receive the RAM preamble transmitted by the UE 120. If the network node 110 successfully receives and decodes the RAM preamble, the network node 110 may then receive and decode the RAM payload.

As shown by reference number 475, the network node 110 may transmit an RAR (sometimes referred to as an RAR message). As shown, the network node 110 may transmit the RAR message as part of a second step of the two-step random access procedure. In some aspects, the RAR message may be referred to as message B, msgB, or a second message in a two-step random access procedure. The RAR message may include some or all of the contents of message 2 (msg2) and message 4 (msg4) of a four-step random access procedure. For example, the RAR message may include the detected PRACH preamble identifier, the detected UE identifier, a timing advance value, a resource allocation (e.g., an uplink grant), and/or contention resolution information.

As shown by reference number 480, as part of the second step of the two-step random access procedure, the network node 110 may transmit a PDCCH communication for the RAR. The PDCCH communication may schedule a PDSCH communication that includes the RAR. For example, the PDCCH communication may indicate a resource allocation (e.g., in DCI) for the PDSCH communication.

As shown by reference number 485, as part of the second step of the two-step random access procedure, the network node 110 may transmit the PDSCH communication for the RAR, as scheduled by the PDCCH communication. The RAR may be included in a MAC PDU of the PDSCH communication. As shown by reference number 490, if the UE 120 successfully receives the RAR, the UE 120 may transmit a HARQ ACK.

“PRACH collision” denotes an event in a wireless network where at least two UEs choose a same PRACH resource (e.g., an RO and PRACH preamble (e.g., sequence)) to transmit PRACH transmissions at the same time, resulting in a collision. Alternatively, or additionally, “PRACH collision” may denote a network node detecting a cyclic shift (CS) for a PRACH preamble, and deriving that multiple UEs are transmitting the CS. A network node may have difficulty identifying and/or may be unable to distinguish between the UEs associated with the collision. Accordingly, the network node may detect the collision as a single UE, and consequently transmit a single RAR (e.g., a single msg2 and/or a single msgB) that includes a single uplink grant. Based at least in part on transmitting on a same RO and/or using a same PRACH preamble, the two UEs may both receive the single RAR (that indicates the PRACH preamble) and may both use the single uplink grant, resulting in a second collision in the uplink grant. The PRACH collision in combination with the second collision may collectively be referred to as a sequence domain collision. The probability of a PRACH collision and/or a sequence domain collision occurring may proportionally increase with a number of UEs accessing a wireless network. The occurrence of a PRACH collision and/or a sequence domain collision may result in a UE failing to access a wireless network and/or experiencing an increased latency in accessing the wireless network.

Various aspects relate generally to multiple PRACH preamble transmissions by a UE. Some aspects more specifically relate to the UE transmitting the multiple PRACH preamble transmissions in a same PRACH repetition cycle (e.g., either through multiple ROs or multiple PRACH preambles in the same RO). In some aspects, a UE may receive system information associated with a network node, and the system information may indicate multiple PRACH preambles to use for a RACH procedure with the network node. Based at least in part on receiving the system information, the UE may transmit, as part of a RACH procedure with the network node, a first transmission comprising a first PRACH preamble of the multiple PRACH preambles and a second transmission comprising a second PRACH preamble of the multiple PRACH preambles. The first transmission and the second transmission may each be a respective first message of the RACH procedure (e.g., a respective msg1 or a respective msgA) and/or may not be a retransmission of the respective first message. In some aspects, the UE may transmit the first transmission and the second transmission in a same PRACH repetition cycle and/or a same PRACH configuration period.

In some aspects, a network node may receive a first transmission including a PRACH preamble and a second transmission including the same PRACH preamble. Based at least in part on receiving multiple transmissions with a same PRACH preamble, the network node may transmit a response message (e.g., a network node response message), and the response message may include a first timing advance associated with the first transmission, and a second timing advance associated with the second transmission. Alternatively, or additionally, the response message may include the PRACH preamble included in the first transmission and the second transmission.

Particular aspects of the subject matter described in this disclosure can be implemented to realize one or more of the following potential advantages. In some examples, by generating and transmitting multiple PRACH preamble transmissions in a same PRACH repetition cycle and/or a same PRACH configuration period, the described techniques can be used to enable a UE to mitigate failure in accessing a wireless network and/or mitigate increasing a latency in accessing the wireless network. To illustrate, a first transmission from a first UE may be part of a first PRACH collision with a transmission from a second UE based at least in part on both UEs selecting a same PRACH preamble. The probability of the second transmission from the first UE being part of a second PRACH collision with another transmission from the second UE and/or a third UE is lower, resulting in an increased probability that at least one of the two transmissions is received by a network node successfully and/or with a collision. Accordingly, generating and transmitting at least two transmissions with different PRACH preambles in a same PRACH repetition cycle and/or a same PRACH configuration period may mitigate the UE failing to access the wireless network and/or may reduce a latency in the UE accessing the wireless network.

As indicated above, FIG. 4 is provided as an example. Other examples may differ from what is described with regard to FIG. 4.

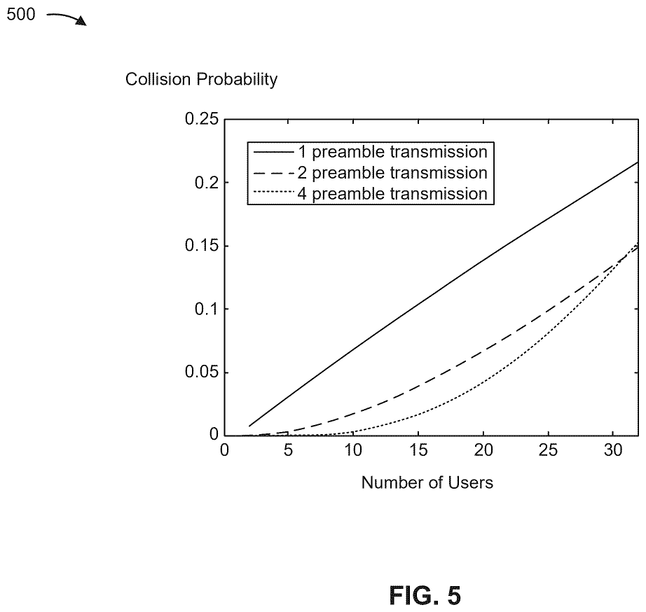

FIG. 5 is a diagram illustrating an example of a collision probability graph 500, in accordance with the present disclosure.

In some aspects, a PRACH collision probability (e.g., a collision probability) is a measure of a likelihood that each PRACH transmission by a first UE has a collision with another PRACH transmission. To illustrate, the collision probability graph 500 is a comparison between a collision probability (shown on a vertical axis) and a number of users (e.g., UEs) in a wireless network (shown on a horizontal axis).

In FIG. 5, the collision probability graph 500 is based at least in part a total number of 128 possible PRACH preambles. For the 128 possible PRACH preambles, the collision probability graph 500 includes a first scenario in which a UE transmits one PRACH transmission using one PRACH preamble (shown through the use of a solid line) in a PRACH repetition cycle and/or a same PRACH configuration period, a second scenario in which the UE transmits two PRACH transmissions using two PRACH preambles (shown through the use of a dashed line) in a same PRACH repetition cycle and/or a same PRACH configuration period, and a third scenario in which the UE transmits four PRACH transmissions using four PRACH transmissions (shown through the use of a dotted line) in a same PRACH repetition cycle and/or a same PRACH configuration period. In the first scenario, the UE may select one of a total number of 128 possible PRACH preambles that are associated with a set of ROs for the PRACH transmission. In the second scenario, the UE may select a first PRACH preamble from a first set of 64 PRACH preambles that are associated with a first set of ROs, and a second PRACH preamble from a second set of 64 preambles that are associated with a second set of ROs. Accordingly, the UE may transmit the first PRACH transmission by selecting a first PRACH preamble from the first set of 64 PRACH preambles, and using a first RO from the first set of ROs that is associated with the first PRACH preamble. The UE may transmit the second PRACH transmission by selecting a second PRACH preamble from the second set of 64 PRACH preambles, and using a second RO from the second set of ROs that is associated with the second PRACH preamble. In the third scenario, the UE may select each of the four PRACH preambles from a respective set of 32 PRACH preambles, where each set of 32 PRACH preambles is associated with a respective set of ROs, and using the respective RO that is associated with the selected PRACH preamble. Thus, each PRACH transmission carries a respective PRACH preamble and uses a respective RO.

As described above, the collision probability graph 500 indicates a likelihood that each PRACH transmission by the UE has a collision with another PRACH transmission. For the first scenario in which the UE transmits one PRACH transmissions, the collision probability graph 500 indicates a probability that the PRACH transmission encounters a collision. For the second scenario in which the UE transmits two PRACH transmissions, the collision probability graph 500 indicates a probability that both of the PRACH transmissions encounter a collision and the third scenario in which the UE transmits four PRACH transmissions, the collision probability graph 500 indicates a probability that all four of the PRACH transmissions encounter a collision. In some aspects, the example collision probability graph 500 is based at least in part on an assumption that if there is no collision in at least one of the transmitted PRACH preambles, a network node may detect the collision-free PRACH transmission, transmit an uplink grant that is associated with the collision-free PRACH transmission, and the uplink grant may be used by the UE for an uplink transmission to the network node (e.g., msg3 for a four-step RACH procedure).

As indicated by the collision probability graph 500, a UE increasing a number of PRACH transmissions that use different PRACH preambles and ROs (e.g., in a same PRACH repetition) may reduce the collision probability and/or may increase a probability that a network node will receive at least one collision-free PRACH transmission. For instance, a comparison between one PRACH transmission and two PRACH transmissions with 16 UEs shows a reduction in a collision probability from 0.11 to 0.04.

As indicated above, FIG. 5 is provided as an example. Other examples may differ from what is described with regard to FIG. 5.

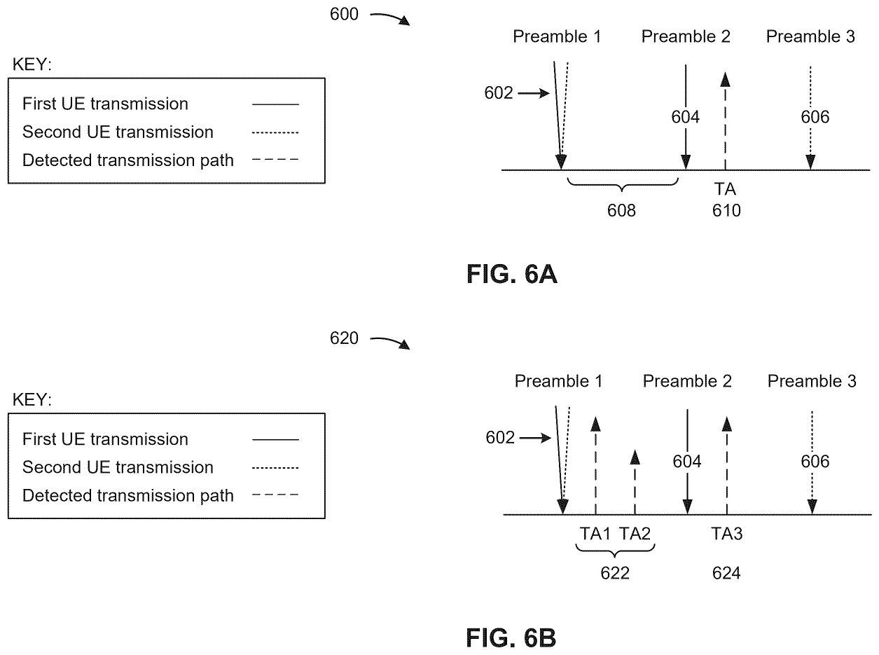

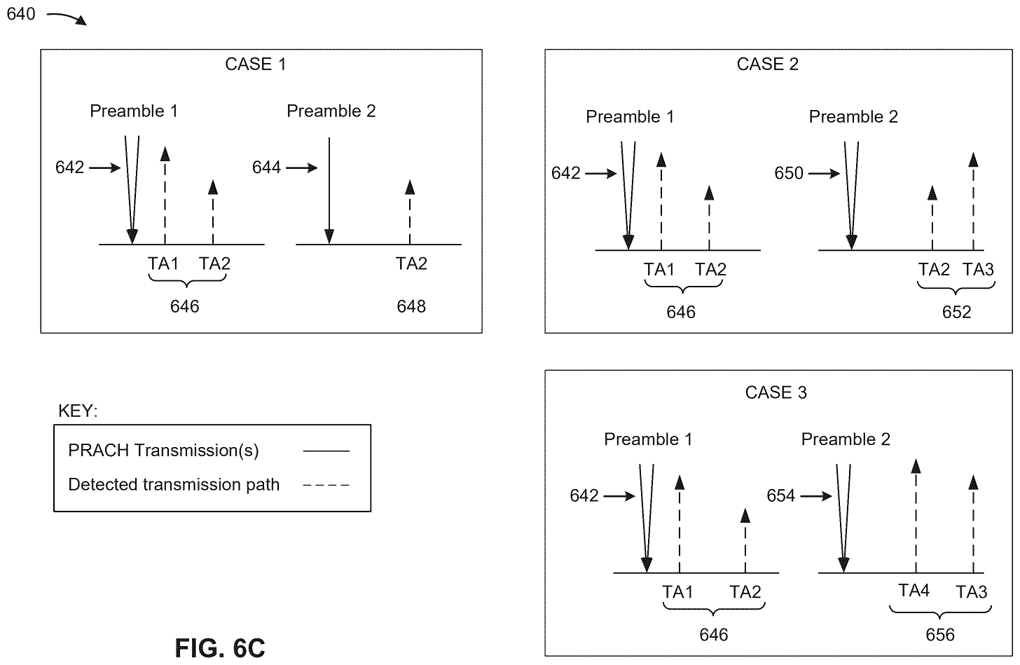

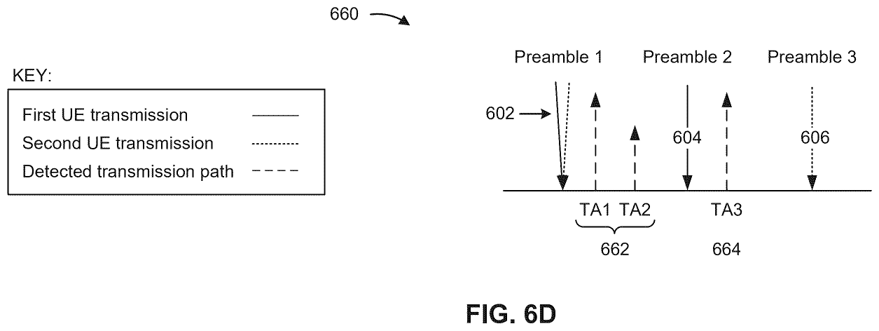

FIGS. 6A, 6B, 6C, and 6D are diagrams illustrating a first example 600, a second example 620, a third example 640, and a fourth example 660, respectively of multiple PRACH transmissions, in accordance with the present disclosure.

In some aspects, a UE may randomly select two or more PRACH preambles from multiple PRACH preambles that are available to the UE. For example, a network node may transmit system information that indicates multiple PRACH preambles that may be used for a RACH procedure with the network node (e.g., an initial access RACH procedure). Alternatively, or additionally, the network node may indicate, in the system information, timing and/or frequency information about one or more ROs that are available to use for a PRACH transmission. Accordingly, the UE may randomly select the two or more PRACH preambles from the multiple PRACH preambles and/or may select one or more ROs to use for multiple PRACH transmissions. In some aspects, the UE may select two or more ROs that have different time domain partitions, and may transmit a respective PRACH transmission in each respective time domain partition. Alternatively, or additionally, the UE may select two or more ROs that have different frequency domain partitions, and may transmit a respective PRACH transmission in each respective frequency partition. In some aspects, the UE may select one RO that the UE uses to transmit two or more PRACH transmissions (e.g., the UE transmits the multiple PRACH transmissions in a same RO). However, the UE may transmit the multiple PRACH transmissions using any combination of ROs that have different time domain partitions, ROs that have different frequency domain partitions, and/or one RO for two or more PRACH transmissions. In some aspects, the UE may select the ROs based at least in part on a current operating condition at the UE.

As one example, in a high mobility operating condition and/or a high interference operating condition, the UE may select the ROs that use different time domain partitions to allow the UE to transmit the PRACH transmissions with more power. To illustrate, selecting different time domain partitions for the ROs may allow the UE to increase a transmission power for each PRACH transmission and satisfy a peak-to-average-power ratio (PAPR) operating condition relative to using a same time domain partition for the PRACH transmissions. As another example, the UE may select the ROs based at least in part on using different frequency domain partitions for the ROs in environments with high multipath (e.g., frequency-specific fading) to diversify the PRACH transmissions in the frequency domain and increase a probability that a network node successfully receives and recovers at least one PRACH transmission.

In some aspects, a network node may analyze a respective signal for each RO indicated by the network node in system information to monitor for a presence of a signal in the RO that includes a CS. In some aspects, the detection of a signal that includes a CS may indicate the presence of a PRACH transmission, and each RO may include one or more signals that carry respective CSs that may be orthogonal (and/or nearly orthogonal) to other CSs. Each detected CS may be associated with a respective transmission path and/or a respective UE. For each detected CS in an RO, the network node may compute and/or derive a respective time delay, a respective timing advance (e.g., that compensates for the respective time delay), and/or a respective signal strength. In some aspects, the network node may use and/or include the computed information in a network node response transmission (e.g., a msg2 in a four-step RACH response and/or a msgB in a two-step RACH response) to one or more UEs.

In the first example 600 shown by FIG. 6A, a UE may transmit multiple PRACH transmissions in a same PRACH repetition cycle and/or a same PRACH configuration period. For instance, as shown by reference number 602 and reference number 604, a first UE may transmit a first PRACH transmission using a first preamble (e.g., Preamble 1) and a second PRACH transmission using a second preamble (e.g., Preamble 2) in the same PRACH repetition cycle. In some aspects, the first PRACH transmission and the second PRACH transmission may each be a respective first message of a RACH procedure and/or may not be retransmissions of a first message. The first PRACH transmission and the second PRACH transmission by the first UE are shown by FIG. 6A through the use of a solid line. As shown by reference number 602 and reference number 606, a second UE may transmit a first PRACH transmission using a same preamble as the first UE (e.g., the first preamble and/or Preamble 1) and a second PRACH transmission using a third preamble (e.g., Preamble 3). The first PRACH transmission and the second PRACH transmission by the second UE are shown by FIG. 6A through the use of a dotted line. A network node may receive at least some of the multiple PRACH transmissions by the first UE and the second UE in a manner that results in a PRACH collision as shown by reference number 602. As one example, the first UE and the second UE may transmit, and the network node may receive, the respective PRACH transmissions in a same RO and/or using a same preamble (e.g., Preamble 1).

In some aspects, the network node may include an ability to detect multiple PRACH transmissions and/or a PRACH collision. That is, the network node may include a collision detection capability. To illustrate, the network node may include a collision detection algorithm that is implemented using any combination of software, hardware, and/or firmware, and the collision detection algorithm may detect the different PRACH transmissions based at least in part on detecting a respective CS includes in each PRACH transmission. In some aspects, the collision detection algorithm may conclude a PRACH collision has occurred based at least in part on detecting multiple CSs in a same RO. Alternatively, or additionally, the network node may calculate, by way of the collision detection algorithm, a power difference and/or a time delay difference between the respective PRACH transmissions using the respective CSs. For example, the network node may identify, by way of the collision detection algorithm, a first CS in the first PRACH transmission by the first UE and a second CS in the first PRACH transmission by the second UE. The network node may use the respective CSs (e.g., the respective signals that carry the respective CSs) to compute a power difference and/or a time delay difference between the PRACH transmissions shown by reference number 602. Accordingly, the network node, by way of the collision detection algorithm, may conclude that a PRACH collision has occurred based at least in part on detecting multiple CSs in an RO, detecting a power difference between the multiple CSs and/or the PRACH transmissions, and/or detecting a time delay difference between the multiple CSs and/or the PRACH transmissions.

Based at least in part on detecting a PRACH collision (e.g., by way of a collision detection algorithm), the network node may respond in a variety of manners. As a first example, based at least in part on detecting a PRACH collision, the network node may not allocate an uplink grant for the preamble that is associated with the PRACH collision (e.g., Preamble 1 in the first example 600). Alternatively, or additionally, the network node may not transmit a network node response message as shown by reference number 608. For example, in a four-step RACH procedure, the network node may not allocate an uplink grant that is designated for a msg3 transmission by a UE and/or may not transmit a msg2 for a preamble that is associated with a PRACH collision. Based at least in part on not detecting a network node response (e.g., a msg2) to a respective PRACH transmission, each UE may determine that the PRACH transmission was a misdetection and/or may retransmit the PRACH transmission with a power ramp up relative to the prior PRACH transmission.

In other aspects, the network node may not detect a PRACH collision, such as the PRACH collision shown by reference number 602. For instance, the network node may detect the PRACH collision as a single PRACH transmission instead of a PRACH collision. In such a scenario, the network node may allocate a single uplink grant to be used by a UE for a UE response message (e.g., a msg3 in a four-step RACH procedure) and/or may transmit a network node response message (e.g., a msg2 in a four-step RACH procedure and/or a msgB in a two-step RACH procedure) that indicates the uplink grant (not shown in FIG. 6A). The multiple UEs associated with the undetected PRACH collision may both receive the network node response message, and both UEs may use the uplink grant, resulting in an uplink collision.

As shown by reference number 610, the network node may detect a single PRACH transmission and/or a single transmission path for a collision-free PRACH transmission (e.g., the second PRACH transmission by the first UE and shown by reference number 604). Based at least in part on detecting a collision-free PRACH transmission, the network node may allocate an uplink grant for a UE response message (e.g., a msg3 in a four-step PRACH procedure) and transmit a network node response message that indicates the uplink grant. In some aspects, the network node response message may include and/or indicate a timing advance (TA) and/or timing correction information that is associated with the collision-free PRACH transmission. The timing advance and/or the timing correction information may be based at least in part on the timing delay that is computed using the CS.

The first UE may monitor for one or more network node response messages that are linked to the PRACH preambles used by the first UE (e.g., the Preamble 1 and the Preamble 2). In the first example 600, the first UE may not detect a first network node response message that is associated with the first preamble (e.g., the first PRACH transmission that indicated Preamble 1), but may detect a second network node response message that is associated with the second preamble (e.g., the second PRACH transmission that indicated Preamble 2). In some aspects, a network node response message may indicate a preamble that is associated with the network node response message and/or an uplink grant. Based at least in part on detecting the second network node response message is linked to the second preamble, the first UE may use the uplink grant that is indicated in second the network node response message to transmit a UE response message, such as a msg3 in a four-step RACH procedure. In some aspects, the UE may detect multiple network node response messages to the multiple PRACH preambles used by the first UE, such as a first network node response message that is associated with the first preamble and a second network node response message that is associated with the second preamble. In such a scenario, the first UE may randomly select a network node response message from the multiple network node response messages and/or an uplink grant from multiple uplink grants indicated by the multiple network node response message. The UE may use the randomly selected uplink grant indicated in the network node response message to transmit a UE response message.

In the second example 620 shown by FIG. 6B, a first UE and a second UE transmit respective first PRACH transmissions using a same preamble (e.g., Preamble 1) that result in a PRACH collision as described with regard to 602 of FIG. 6A, the first UE transmits a second PRACH transmission using a second preamble as described with regard to reference number 604 of FIG. 6A, and the second UE transmits a second PRACH transmission using a third preamble as described with regard to reference 606 of FIG. 6A. In a similar manner as described with regard to FIG. 6A, a network node may include a collision detection capability that enables the network node to detect the PRACH collision shown by reference number 602, such as through the use of a collision detection algorithm that detects multiple CSs, detects a power difference between the multiple CSs, and/or detects a time delay difference between the multiple CSs. Accordingly, based at least in part on detecting a PRACH collision, the network node may derive that the PRACH collision is a result of multiple UEs transmitting multiple PRACH transmissions via multiple transmission paths and/or may detect the multiple transmission paths (e.g., by detecting a respective CS for each transmission path, computing a respective signal power level for each detected transmission path, and/or computing a respective timing advance and/or timing delay for each detected transmission path).

In some aspects, the network node may allocate a respective uplink grant to each detected transmission path of the PRACH collision. To illustrate, with regard to the second example 620, the network node may detect a first transmission path that is associated with the first UE and a second transmission path that is associated with the second UE. As shown by reference number 622, based at least in part on detecting the first transmission path and the second transmission path, the network node may compute a first timing advance (shown as TA1) associated with the first transmission path and a second timing advance (shown as TA2) associated with the second transmission path. Alternatively, or additionally, the network node may transmit a first network node response message to the PRACH collision associated with the first preamble (e.g., Preamble 1) and the first network node response message may indicate each timing advance calculated for the first preamble (e.g., the first timing advance TA1 and the second timing advance TA2) and/or may indicate the first preamble. The network node may indicate, in the first network node response message, a respective uplink grant for each timing advance in, such as by indicating a first uplink grant that is associated with the first timing advance and a second uplink grant that is associated with the second timing advance in the first network node response message. While the above example includes the network node indicating two timing advances in combination with two uplink grants, other examples may include the network node indicating multiple timing advances (e.g., more than two) in combination with a respective uplink grant for each timing advance of the multiple timing advances. Accordingly, the network node may allocate an uplink grant for each detected transmission path, and each uplink grant may be used by a respective UE for a respective UE response message (e.g., a msg3 in a four-step RACH procedure). In some aspects, the network node may indicate a respective signal power level for each transmission path in the first network node response message.

The network node may transmit a respective network node response message for each preamble that is detected by the network node (e.g., each preamble of the multiple preambles indicated by the network node in system information). To illustrate, as shown by reference number 624, the network node may detect a single PRACH transmission (e.g., a collision-free PRACH transmission) and/or a single transmission path that is associated with the second preamble. Based at least in part on detecting the single transmission path, the network node may transmit a second network node response message that indicates and/or includes a third timing advance (shown as TA3) that is associated with the detected transmission path. Alternatively, or additionally, the second network node response message may indicate an uplink grant that is linked to the third timing advance and/or a signal power level, where the network node may compute the third timing advance and/or the signal power level in a similar manner as described above.

In the second example 620, the first network node response message includes multiple timing advances and multiple uplink grants, while the second network node response message includes a single timing advance and a single uplink grant. However, in other examples, the network node may indicate and/or include multiple timing advances and/or multiple uplink grants in multiple network node response messages (e.g., the first network node response message and the second network node response message), such as in a scenario where the network node detects a PRACH collision and/or multiple transmission paths for more than one preamble. Thus, the network node may transmit a respective network node response message for each detected preamble in each RO, and the respective network node response message may indicate and/or include multiple timing advances in combination with a respective uplink grant for each timing advance.

Based at least in part on transmitting multiple PRACH transmissions with different PRACH preambles in a same PRACH repetition cycle and/or a same PRACH configuration period, a UE may monitor for multiple network node response messages. That is, the UE may monitor for a respective network node response message for each PRACH transmission generated and transmitted by the UE. In some aspects, the UE may not detect a network node response message for any of the multiple PRACH transmissions that are transmitted by the UE, and the UE may process the lack of responses as a misdetection and/or a failure. Based at least in part on the misdetection and/or failure, the UE may retransmit the multiple PRACH transmissions with a power ramp that is relative to the prior PRACH transmission. For example, the first UE may retransmit the first PRACH transmission associated with the first preamble using a first power ramp that is relative to the prior transmission of the first PRACH transmission and the second PRACH transmission associated with the second preamble using a second power ramp that is relative to the prior transmission of the second PRACH transmission.

In other aspects, the UE may detect one or more network node responses message to the preamble(s) transmitted by the UE. The UE may decode each network node response message to recover timing advance information and/or uplink grant(s) that are indicated by each network node response message. Based at least in part on detecting multiple timing advances in a network node response message, the UE may select one of the timing advances (and associated uplink grant) using a mapping between the multiple preambles transmitted by the UE as described below with regard to FIG. 6C. The UE may then use the selected uplink grant linked to the selected timing advance for a UE response message (e.g., a msg3 in a four-step RACH procedure).

The third example 640 shown by FIG. 6C includes three cases of multiple PRACH transmission scenarios. In Case 1, a UE may transmit a first PRACH transmission using a first preamble (e.g., Preamble 1) and a second PRACH transmission using a second preamble (e.g., Preamble 2). In a similar manner as described with regard to the first example 600 and the second example 620, the first PRACH transmission and the second PRACH transmissions may be transmitted by the UE in a same PRACH repetition cycle. As shown by reference number 642, a network node may detect the first PRACH transmission as part of a PRACH collision, and, as shown by reference number 644, the network node may detect the second PRACH transmission as a collision-free PRACH transmission. In some aspects, the network node may transmit a first network node response message that is associated with the first preamble, and the first network node response message may include a timing advance for each detected transmission path. In the third example 640, the first network node response message includes a first timing advance (shown as TA1) and a second timing advance (shown as TA2) as shown by reference number 646, and each timing advance may be associated with a respective uplink grant. Alternatively, or additionally, the first network node response message may include a respective signal power level for each detected transmission path. In Case 1, the network node detects the second preamble as a single PRACH transmission and/or a single transmission path. Accordingly, and as shown by reference number 648, the network node may transmit a second network node response message that includes a single timing advance (shown as TA2) that is based at least in part on the single detected transmission path associated with the second preamble. In a similar manner as the first network node response message, the second network node response message may indicate and/or include an uplink grant that is associated with the detected transmission path and/or a signal power level that is associated with the detected transmission path.

In some aspects, the UE may include a collision detection capability that enables the UE to select an uplink grant from multiple uplink grants for a same preamble, such as the multiple uplink grants that may be included in a network node response message and/or multiple uplink grants from multiple network node response messages. To illustrate, the UE may receive the first network node response message and derive that the first network node response message is associated with a first preamble (e.g., Preamble 1) transmitted by the UE as part of a multiple PRACH transmission procedure. The UE may also receive the second network node response message and derive that the second network node response message is associated with a second preamble (e.g., Preamble 2) transmitted by the UE as part of the multiple PRACH transmission procedure. In some aspects, the UE may analyze the network node response messages, such as by comparing the multiple timing advances and/or multiple signal power levels included in the first network node response message to the single timing advance and/or single signal power level include in the second network node response message. That is, the UE may compare the timing advances and/or signal power levels that are included and/or indicated in each network node response message received by the UE that is associated with the preambles used by the UE for a multiple PRACH transmission.

In analyzing the network node response messages, the UE may compute that the first network node response message and the second network node response message include a common timing advance. For instance, the UE may determine that the second timing advance in the first network node response message (e.g., TA2) is commensurate with the single timing advance in the second network node response, such as by determining that the second timing advance and the single timing advance are within a threshold of one another. Additionally, or alternatively, in some examples, the UE may determine that the first network node response message and the second network node response message may include a common signal power level (e.g., signal power levels within a threshold of one another). Based at least in part on identifying a common timing advance (and/or a common signal power level), the UE may derive that the common timing advance is associated with the UE and may select the uplink grant from the network node response message that is associated with the collision-free PRACH transmission (e.g., the network node response message with the single uplink grant). Accordingly, the UE may identify a common metric (e.g., a timing advance and/or a signal power level) between at least two network node response messages that are associated with the preambles used by the UE in a multiple PRACH transmission, and the UE may determine that the common metric is associated with the UE.

In some aspects, the UE may not identify a common timing advance and/or a common signal power level in the first network node response message and the second network node response message. As one example, the UE may determine that none of the timing advances are within a first threshold of one another. As another example, the UE may determine that none of the signal power levels are within a second threshold of one another. Accordingly, the UE may determine that the multiple PRACH transmission is a misdetection and/or a failure. Based at least in part on the misdetection and/or failure, the UE may retransmit the multiple PRACH transmissions with a power ramp that is relative to the prior PRACH transmission. For example, the UE may retransmit the first PRACH transmission associated with the first preamble using a first power ramp that is relative to the prior transmission of the first PRACH transmission and the second PRACH transmission associated with the second preamble using a second power ramp that is relative to the prior transmission of the second PRACH transmission.

In Case 2, the UE may transmit a first PRACH transmission using a first preamble and a second PRACH transmission using a second preamble in a similar manner as described with regard to Case 1. As shown by reference number 642, the network node may detect a PRACH collision for the first preamble, such as a PRACH collision that includes the first PRACH transmission from the UE. In Case 2, the network node may transmit a first network node response message that is associated with the first preamble, and the first network node response message may include a first timing advance (shown as TA1) and a second timing advance (shown as TA2) as shown by reference number 646 and described with regard to Case 1. The first network node response message may include and/or indicate a respective uplink and/or a respective signal power level for each timing advance.

As shown by reference number 650, the network node may detect a second PRACH collision that is associated with the second preamble, such as a second PRACH collision that includes the second PRACH transmission by the UE. The network node may detect multiple transmission paths for the second PRACH collision, and may calculate a timing advance and/or a signal power level for each detected transmission path. As shown by reference number 652, the network node may transmit a second network node response message that is associated with the second preamble and includes multiple timing advances: the second timing advance (shown as TA2) that is associated with the second PRACH transmission by the UE and a third timing advance (shown as TA3) that is associated with a PRACH transmission by another UE. The second network node response message may indicate and/or include a respective uplink grant for each timing advance and/or each detected transmission path. Alternatively, or additionally, the second network node response message may indicate and/or include a respective signal power level for each timing advance and/or each detected transmission path.

In a similar manner as described with regard to Case 1, the UE may include a collision detection capability that enables the UE to select an uplink grant from multiple uplink grants. In Case 2, UE may receive and decode both the first network node response message and the second network node response message based at least in part on the first network node response message and the second network node response message being associated with a respective preamble transmitted by the UE as part of a multiple PRACH transmission procedure. In some aspects, the UE may compare the multiple timing advances and/or multiple signal power levels included in the first network node response message to the multiple timing advances and/or multiple signal power levels includes in the second network node response message. In a similar manner as described with regard to Case 1, the UE may determine that the first network node response message and the second network node response message include a common timing advance (e.g., TA2), but in other examples, the UE may determine that the first network node response message and the second network node response message include a common signal power level. Based at least in part on identifying a common timing advance (and/or a common signal power level), the UE may derive that the common timing advance is associated with the UE, and may randomly select between the uplink grant indicated by the first network node message that is associated with the common timing advance and the uplink grant indicated by the second network node response message that is associated with the common timing advance. Accordingly, the UE may identify a common metric (e.g., a timing advance and/or a signal power level) between at least two network node response messages that are associated with the preambles used by the UE in a multiple PRACH transmission, and the UE may randomly select an uplink grant from at least two uplink grants that are associated with the common metric. That is, the UE may randomly select between a first uplink grant that is associated with a first preamble used by the UE and a second uplink grant that is associated with a second preamble used by the UE based at least in part on the multiple network node response messages each including multiple uplink grants.

In some aspects, the UE may not identify a common timing advance and/or a common signal power level in the first network node response message and the second network node response message. As one example, the UE may determine that none of the timing advances are within a first threshold of one another. As another example, the UE may determine that none of the signal power levels are within a second threshold of one another. Accordingly, the UE may determine that the multiple PRACH transmission is a misdetection and/or a failure. Based at least in part on the misdetection an/do failure, the UE may retransmit the multiple PRACH transmissions with a power ramp that is relative to the prior PRACH transmission. For example, the UE may retransmit the first PRACH transmission associated with the first preamble using a first power ramp that is relative to the prior transmission of the first PRACH transmission and the second PRACH transmission associated with the second preamble using a second power ramp that is relative to the prior transmission of the second PRACH transmission.

In Case 3, the UE may transmit a first PRACH transmission using a first preamble and a second PRACH transmission using a second preamble in a similar manner as described with regard to Case 1 and Case 2. As shown by reference number 642, the network node may detect a PRACH collision for the first preamble, such as a PRACH collision that includes the first PRACH transmission from the UE. In Case 3, the network node may transmit a first network node response message that is associated with the first preamble, and the first network node response message may include a first timing advance (shown as TA1) and a second timing advance (shown as TA2) as shown by reference number 646 and described with regard to Case 1 and Case 2. The first network node response message may include and/or indicate a respective uplink and/or a respective signal power level for each timing advance.

As shown by reference number 654, the network node may detect a second PRACH collision that is associated with the second preamble. The network node may detect multiple transmission paths for the second PRACH collision, and may calculate a timing advance and/or a signal power level for each detected transmission path. As shown by reference number 656, the network node may transmit a second network node response message that is associated with the second preamble and includes multiple timing advances: a third timing advance (shown as TA3) and a fourth timing advance (shown as TA4). The detected transmission paths detected by the network node may or may not be associated with the UE. Alternatively, or additionally, the metrics generated by the network node (e.g., a timing advance and/or a signal power level) may or may not be associated with the UE. That is, the network node may not detect the second PRACH transmission by the UE and/or the network node may calculate metrics for the second PRACH transmission by the UE that are not commensurate with the metrics for the first PRACH transmission. The second network node response message may indicate and/or include a respective uplink grant for each timing advance and/or each detected transmission path. Alternatively, or additionally, the second network node response message may indicate and/or include a respective signal power level for each timing advance and/or each detected transmission path.

In a similar manner as described with regard to Case 1 and Case 2, the UE may include a collision detection capability that enables the UE to select an uplink grant from multiple uplink grants. In Case 3, the UE may receive and decode both the first network node response message and the second network node response message based at least in part on the first network node response message and the second network node response message being associated with a respective preamble transmitted by the UE as part of a multiple PRACH transmission procedure. The UE may compare the multiple timing advances and/or multiple signal power levels included in the first network node response message to the multiple timing advances and/or multiple signal power levels includes in the second network node response message. Based at least in part on the comparison, the UE may determine that the first network node response message does not include a common timing advance (or a common signal power level) with the second network node response message. As one example, the UE may determine that none of the timing advances are within a first threshold of one another. As another example, the UE may determine that none of the signal power levels are within a second threshold of one another. Accordingly, the UE may determine that the multiple PRACH transmission is a misdetection and/or a failure. Based at least in part on the misdetection an/do failure, the UE may retransmit the multiple PRACH transmissions with a power ramp that is relative to the prior PRACH transmission. For example, the UE may retransmit the first PRACH transmission associated with the first preamble using a first power ramp that is relative to the prior transmission of the first PRACH transmission and the second PRACH transmission associated with the second preamble using a second power ramp that is relative to the prior transmission of the second PRACH transmission.

In the fourth example 660 shown by FIG. 6D, a first UE and a second UE transmit respective first PRACH transmissions using a same preamble that result in a PRACH collision as described with regard to 602 of FIG. 6A and FIG. 6B, the first UE transmits a second PRACH transmission using a second preamble as described with regard to reference number 604 of FIG. 6A and FIG. 6B, and the second UE transmits a second PRACH transmission using a third preamble as described with regard to reference 606 of FIG. 6A and FIG. 6B. In a similar manner as described with regard to FIG. 6A and FIG. 6B, a network node may include a collision detection capability that enables the network node to detect the PRACH collision shown by reference number 602, such as through the use of a collision detection algorithm that detects multiple CSs, detects a power difference between the multiple CSs, and/or detects a time delay difference between the multiple CSs. Accordingly, based at least in part on detecting a PRACH collision, the network node may derive that the PRACH collision is a result of multiple UEs transmitting multiple PRACH transmissions via multiple transmission paths and/or may detect the multiple transmission paths (e.g., by detecting a respective CS for each transmission path, computing a respective signal power level for each detected transmission path, and/or computing a respective timing advance and/or timing delay for each detected transmission path).

In some aspects, the network node may allocate a shared uplink grant to each detected transmission path of the PRACH collision. To illustrate, for the first preamble, the network node may detect a first transmission path that is associated with the first UE and a second transmission path that is associated with the second UE. As shown by reference number 662, based at least in part on detecting the first transmission path and the second transmission path, the network node may compute a first timing advance (shown as TA1) associated with the first transmission path and a second timing advance (shown as TA2) associated with the second transmission path. Alternatively, or additionally, the network node may transmit a first network node response message to the PRACH collision associated with the first preamble (e.g., Preamble 1) and the first network node response message may indicate each timing advance calculated for the first preamble (e.g., the first timing advance TA1 and the second timing advance TA2) and/or may indicate the first preamble. The network node may indicate, in the first network node response message, a shared uplink grant that is associated with each timing advance. That is, the uplink grant may be shared between all of the different detected transmission paths associated with the first preamble. In some aspects, the network node may indicate a respective signal power level for each detected transmission path in the first network node response message.

The network node may transmit a respective network node response message for each preamble that is detected by the network node (e.g., each preamble of the multiple preambles indicated by the network node in system information). To illustrate, as shown by reference number 624, the network node may detect a single PRACH transmission (e.g., a collision-free PRACH transmission) and/or a single transmission path that is associated with the second preamble. As shown by reference number 664, based at least in part on detecting the single transmission path, the network node may transmit a second network node response message that indicates and/or includes a third timing advance (shown as TA3) that is associated with the detected transmission path. Alternatively, or additionally, the second network node response message may indicate an uplink grant that is linked to the third timing advance and/or a signal power level, where the network node may compute the third timing advance and/or the signal power level in a similar manner as described above.

In the example 660, the first network node response message includes multiple timing advances that are associated with a shared uplink grant (e.g., shared between the different transmission paths), while the second network node response message includes a single timing advance and a single uplink grant. However, in other examples, the network node may indicate and/or include multiple timing advances that are associated with a shared uplink grant in multiple network node response messages (e.g., the first network node response message and the second network node response message), such as in a scenario where the network node detects a PRACH collision and/or multiple transmission paths for more than one preamble. Thus, the network node may transmit a respective network node response message for each detected preamble in each RO, and the respective network node response message may indicate and/or include multiple timing advances in combination with a respective shared uplink grant for the multiple timing advances of a respective preamble. Accordingly, the shared uplink grant may be associated with all of the detected transmission paths (e.g., by a network node) for a preamble.

Based at least in part on transmitting multiple PRACH transmissions with different PRACH preambles in a same PRACH repetition cycle, a UE may monitor for multiple network node response messages. That is, the UE may monitor for a respective network node response message for each PRACH transmission generated and transmitted by the UE. In some aspects, the UE may not detect a network node response message for any of the multiple PRACH transmissions that are transmitted by the UE, and the UE may process the lack of responses as a misdetection and/or a failure. Based at least in part on the misdetection and/or failure, the UE may retransmit the multiple PRACH transmissions with a power ramp that is relative to the prior PRACH transmission. For example, the UE may retransmit the first PRACH transmission associated with the first preamble using a first power ramp that is relative to the prior transmission of the first PRACH transmission and the second PRACH transmission associated with the second preamble using a second power ramp that is relative to the prior transmission of the second PRACH transmission.

In other aspects, the UE may detect one or more network node responses message to the preamble(s) transmitted by the UE. The UE may decode each network node response message to recover timing advance information and/or uplink grant(s) that are indicated by each network node response message. Based at least in part on detecting multiple timing advances in a network node response message, the UE may select one of the timing advances (and associated uplink grant)

In some aspects, the UE may include a collision detection capability that enables the UE to select an uplink grant from multiple uplink grants for a same preamble, such as the multiple uplink grants that may be included in a network node response message and/or multiple uplink grants from multiple network node response messages. To illustrate, the UE may receive the first network node response message and derive that the first network node response message is associated with a first preamble (e.g., Preamble 1) transmitted by the UE as part of a multiple PRACH transmission procedure. The UE may also receive the second network node response message and derive that the second network node response message is associated with a second preamble (e.g., Preamble 2) transmitted by the UE as part of the multiple PRACH transmission procedure. In some aspects, the UE may analyze the network node response messages, such as by comparing the multiple timing advances and/or multiple signal power levels included in the first network node response message to the single timing advance and/or the single signal power level include in the second network node response message. That is, the UE may compare the timing advances and/or the signal power levels that are included and/or indicated in each network node response message received by the UE that is associated with the preambles used by the UE for a multiple PRACH transmission.

In analyzing the network node response messages, the UE may compute that the first network node response message and the second network node response message include a common timing advance. For instance, the UE may determine that the second timing advance in the first network node response message (e.g., TA2) is commensurate with the single timing advance in the second network node response, such as by determining that the second timing advance and the single timing advance are within a threshold of one another. However, in other examples, the UE may determine that the first network node response message and the second network node response message may include a common signal power level (e.g., signal power levels within a threshold of one another). Based at least in part on identifying a common timing advance (and/or a common signal power level), the UE may derive that the common timing advance is associated with the UE and may select the uplink grant from the network node response message that is associated with the collision-free PRACH transmission (e.g., the network node response message with the single uplink grant). Accordingly, the UE may identify a common metric (e.g., a timing advance and/or a signal power level) between at least two network node response messages that are associated with the preambles used by the UE in a multiple PRACH transmission, and the UE may determine that the common metric is associated with the UE.

While the fourth example 660 is a multiple PRACH transmission example that includes at least one collision-free PRACH transmission, other examples may include multiple PRACH collisions, such as a the multiple PRACH collisions described with regard to Case 2 described with regard to FIG. 6C and Case 3 described with regard to FIG. 6C. In Case 2, the UE receives multiple timing advances (and/or multiple signal power levels) in each network node response message that is associated with a respective preamble used by the UE. In such a scenario, the UE may determine that the first network node response message and the second network node include a common timing advance (e.g., TA2). However, based at least in part on the uplink grants indicated by each network node response message being a shared uplink grant between each detected transmission path associated with a respective PRACH preamble, the UE may conclude that a PRACH collision occurred for all of the preambles (e.g., the first preamble and the second preamble) and/or may determine that the multiple PRACH transmissions resulted in a misdetection and/or a failure. Accordingly, the UE May retransmit the multiple PRACH transmissions with a power ramp that is relative to the prior PRACH transmission. For example, the UE may retransmit the first PRACH transmission associated with the first preamble using a first power ramp that is relative to the prior transmission of the first PRACH transmission and the second PRACH transmission associated with the second preamble using a second power ramp that is relative to the prior transmission of the second PRACH transmission.

In Case 3, the UE receives multiple timing advances (and/or multiple signal power levels) in each network node response message that is associated with a respective preamble used by the UE, and the UE is unable to identify a common metric (e.g., a common timing advance and/or a common signal power level). For example, the UE is unable to identify two timing advances and/or two signal power levels that are in separate network node response messages and are within a threshold of one another. Based at least in part on being unable to identify a common metric, the UE may conclude that a PRACH collision occurred for all of the preambles (e.g., the first preamble and the second preamble) and/or may determine that the multiple PRACH transmissions resulted in a misdetection and/or a failure. Accordingly, the UE may retransmit the multiple PRACH transmissions with a power ramp that is relative to the prior PRACH transmission. For example, the UE may retransmit the first PRACH transmission associated with the first preamble using a first power ramp that is relative to the prior transmission of the first PRACH transmission and the second PRACH transmission associated with the second preamble using a second power ramp that is relative to the prior transmission of the second PRACH transmission.

A UE transmitting multiple PRACH preamble transmissions in a same PRACH repetition cycle may mitigate failure in accessing a wireless network and/or mitigate increasing a latency in accessing the wireless network. To illustrate, a first transmission from a first UE may be part of a first PRACH collision with a transmission from a second UE based at least in part on both UEs selecting a same PRACH preamble. The probability of the second transmission from the first UE being part of a second PRACH collision with another transmission from the second UE and/or a third UE is lower, resulting in an increased probability that at least one of the two transmissions is received by a network node successfully and/or with a collision. Accordingly, the UE transmitting at least two transmissions with different PRACH preambles in a same PRACH repetition cycle may mitigate the UE failing to access the wireless network and/or may reduce a latency in the UE accessing the wireless network.

As indicated above, FIGS. 6A, 6B, 6C, and 6D are provided as examples. Other examples may differ from what is described with regard to FIGS. 6A, 6B, 6C, and 6D.

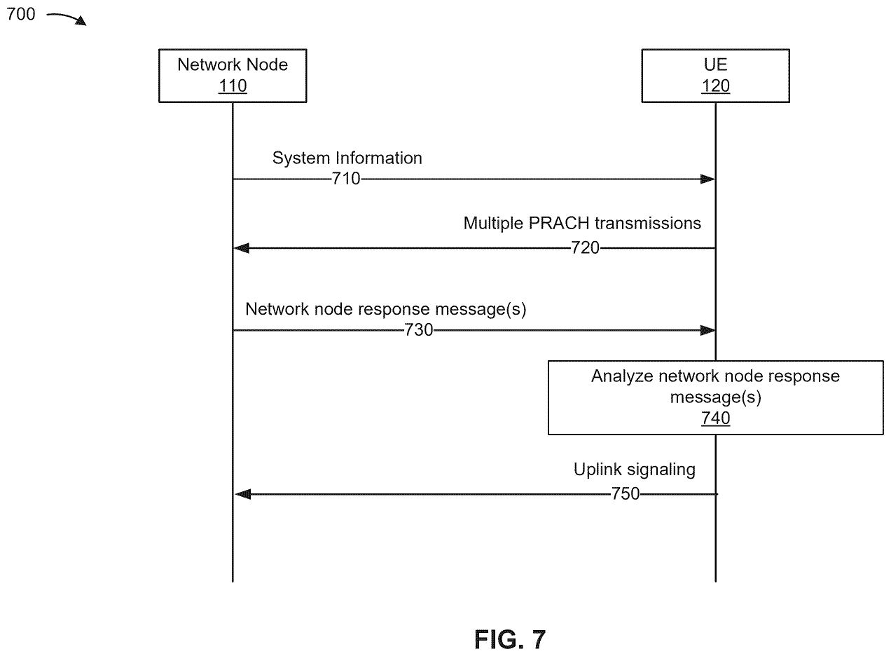

FIG. 7 is a diagram illustrating an example 700 of a wireless communication process between a network node (e.g., the network node 110) and a UE (e.g., the UE 120), in accordance with the present disclosure.

As shown by reference number 710, a network node 110 may transmit, and a UE 120 may receive, system information. To illustrate, the network node 110 may transmit an SSB that enables the UE 120 to synchronize to the network node 110 and/or may transmit one or more SIBs that indicate PRACH configuration information, multiple PRACH preambles, and/or random access resource configuration information (e.g., RO time-frequency configurations).

As shown by reference number 720, the UE 120 may transmit, and the network node 110 may receive, multiple PRACH transmissions. In some aspects, each PRACH transmission may be a respective first message of a RACH procedure, such as a respective msg1 in a four-step RACH procedure and/or a respective msgA in a two-step RACH procedure. Alternatively, or additionally, each PRACH transmission may be a respective initial first message of a RACH procedure and not a retransmission of the first message of the RACH procedure. The UE 120 may transmit the multiple PRACH transmissions in a same PRACH repetition cycle, and each PRACH transmission may be associated with and/or carry a respective PRACH preamble that was indicated by the network node in system information. The UE 120 may use different ROs and/or a same RO to transmit the multiple PRACH transmissions. To illustrate, the UE 120 may transmit the multiple PRACH transmissions using different time domain ROs, different frequency domain ROs, and/or a same RO for at least two PRACH transmissions.

While FIG. 7 shows the network node 110 receiving the multiple PRACH transmissions from a single UE (e.g., the UE 120), other examples may include the network node 110 receiving one or more PRACH transmissions from multiple UEs. For example, the network node 110 may receive a first PRACH transmission and a second PRACH transmission from the UE 120 shown by FIG. 7, and the first PRACH transmission and the second PRACH transmission may include respective PRACH preambles as described herein. In some aspects, the network node 110 may receive multiple PRACH transmissions from other UEs (e.g., other UEs 120) in a manner that results in a PRACH collision as described with regard to FIGS. 6A, 6B, 6C, and 6D. For example, the UE 120 shown by FIG. 7 may be a first UE 120, and the network node 110 may receive a third PRACH transmission from a second UE 120 that indicates a same PRACH preamble that is used by the first UE 120. Alternatively, or additionally, the network node 110 may receive a fourth PRACH transmission from a fourth UE 120 that indicates a second PRACH preamble used by the first UE 120. The network node 110 may monitor each RO that is indicated in the system information for a PRACH transmission. Accordingly, the network node 110 may, in some scenarios, receive a PRACH collision.

As shown by reference number 730, the network node 110 may transmit, and the UE 120 may receive, one or more network node response messages. In some aspects, a network node response message may be a response message that is part of a RACH procedure, such as a msg2 that is part of a four-step RACH procedure and/or a msgB that is part of a two-step PRACH procedure. The network node 110 may transmit a respective network node response message for each PRACH transmission and/or each PRACH preamble (e.g., of the multiple PRACH preambles indicated by the network node 110 in the system information) that the network node 110 detects in an RO (e.g., also indicated by the network node 110 in the system information).

Each network node response message may be associated with a respective PRACH preamble, and each network node response message may include information for one or more transmission paths that the network node 110 detects for the respective PRACH preamble. For example, the network node 110 may indicate, in a network node response message, one or more timing advances as described with regard to FIG. 6B, FIG. 6C, and FIG. 6D. Alternatively, or additionally, the network node 110 may indicate, in the network node response message, one or more signal power levels as described with regard to FIG. 6B, FIG. 6C, and FIG. 6D. Each timing advance and/or each signal power level may be associated with a respective transmission path for the respective PRACH preamble. In some aspects, a network node response message may indicate the PRACH preamble that is associated with the network node response message. The network node response message may indicate an association between any combination of the respective transmission path, the respective timing advance, and/or the respective signal power level.

In some aspects, the network node 110 may allocate a respective uplink grant for each detected transmission path that is associated with a PRACH preamble as described with regard to FIGS. 6B and 6C. Accordingly, a network node response message may indicate a respective uplink grant for each detected transmission path include and/or indicated by the network node response message. In other aspects, the network node 110 may allocate a shared uplink grant that is common and/or shared between the detected transmission path(s) that are associated with a PRACH preamble as described with regard to FIG. 6D.

While the example 700 includes the network node 110 transmitting network node response message(s), other examples may include the network node 110 not transmitting (e.g., refraining from transmitting) a network node response message. To illustrate, based at least in part on detecting a PRACH collision, the network node 110 may not transmit (e.g., refrain from transmitting) a network node response message for the PRACH preamble that is associated with the PRACH collision as described with regard to FIG. 6A.

As shown by reference number 740, the UE 120 may analyze the network node response messages. For example, the UE 120 may analyze each network node response message to determine if the network node response message includes one or more timing advances and/or one or more signal power levels. In some aspects, the UE 120 may analyze each network node response message to determine if the network node response message includes and/or indicates a respective uplink grant for each detected transmission path, while in other aspects, the UE 120 may analyze each network node response message to determine if the network node response message includes a shared uplink grant that common and/or shared by the multiple detected transmission paths. Each detected transmission path may be indicated by the inclusion and/or indication of a respective timing advance and/or respective signal power level that is associated with the detected transmission path.

In some aspects, as part of analyzing the network node response messages, the UE 120 may select an uplink grant to use for transmission of a UE response message, such as a msg3 in a four-step RACH procedure. For example, the UE 120 may identify a common metric (e.g., a common timing advance and/or a common signal power level) between multiple network node response messages, and use the common metric to select an uplink grant. In some aspects, the UE 120 may select an uplink grant that is linked to a collision-free PRACH transmission as described with regard to FIG. 6B. As another example, the UE 120 may randomly select between two uplink grants that are associated with different PRACH preambles and the common metric as described with regard to FIG. 6C. However, the UE 120 may determine, based at least in part on analyzing, that the multiple PRACH transmissions described with regard to reference number 720 may be a misdetection and/or a failure as described with regard to FIG. 6A, FIG. 6B, FIG. 6C, and FIG. 6D.

As shown by reference number 750, the UE 120 may transmit, and the network node 110 may receive, one or more uplink transmissions. In some aspects, the UE 120 may transmit a UE response message that is part of a RACH procedure, such as msg3 that is part of a four-step RACH procedure and/or a HARQ ACK that is part of a two-step RACH procedure. In some aspects, the UE 120 may use an uplink grant that is indicated by a network node response message to transmit the uplink transmission, such as a msg3 that is part of a four-step RACH procedure.

In other aspects, the UE 120 may not use an uplink grant indicated by a network node response message to transmit an uplink transmission. To illustrate, the UE 120 may retransmit the multiple PRACH transmissions described with regard to reference number 720 based at least in part on failing to detect any response message (e.g., any network node response message) to any of the multiple PRACH transmissions. As another example, the UE 120 may retransmit the multiple PRACH transmissions based at least in part on determining that there is no common metric (e.g., no common timing advance and/or no common power level) in multiple network node response messages. The UE 120 may retransmit the multiple PRACH transmissions using a respective power ramp for each PRACH retransmission.

A UE transmitting multiple PRACH preamble transmissions in a same PRACH repetition cycle may mitigate failure in accessing a wireless network and/or mitigate increasing a latency in accessing the wireless network. To illustrate, a first transmission from a first UE may be part of a first PRACH collision with a transmission from a second UE based at least in part on both UEs selecting a same PRACH preamble. The probability of the second transmission from the first UE being part of a second PRACH collision with another transmission from the second UE and/or a third UE is lower, resulting in an increased probability that at least one of the two transmissions is received by a network node successfully and/or with a collision. Accordingly, the UE transmitting at least two transmissions with different PRACH preambles in a same PRACH repetition cycle may mitigate the UE failing to access the wireless network and/or may reduce a latency in the UE accessing the wireless network.

As indicated above, FIG. 7 is provided as an example. Other examples may differ from what is described with regard to FIG. 7.

FIG. 8 is a diagram illustrating an example process 800 performed, for example, at a UE or an apparatus of a UE, in accordance with the present disclosure. Example process 800 is an example where the apparatus or the UE (e.g., UE 120) performs operations associated with multiple PRACH preamble transmissions by a UE.

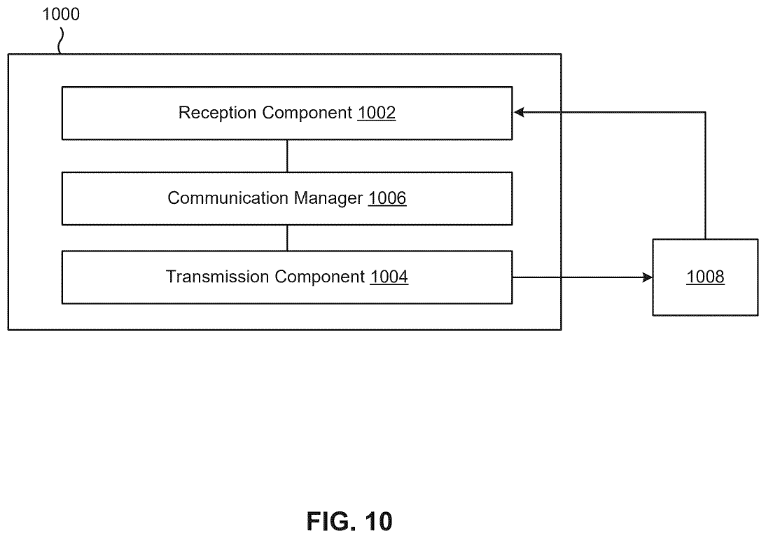

As shown in FIG. 8, in some aspects, process 800 may include receiving system information associated with a network node, the system information indicating multiple PRACH preambles to use for a RACH procedure with the network node (block 810). For example, the UE (e.g., using reception component 1002 and/or communication manager 1006, depicted in FIG. 10) may receive system information associated with a network node, the system information indicating multiple PRACH preambles to use for a RACH procedure with the network node, as described above.

As further shown in FIG. 8, in some aspects, process 800 may include transmitting, as part of the RACH procedure with the network node, a first transmission including a first PRACH preamble of the multiple PRACH preambles and a second transmission including a second PRACH preamble of the multiple PRACH preambles (block 820). For example, the UE (e.g., using transmission component 1004 and/or communication manager 1006, depicted in FIG. 10) may transmit, as part of the RACH procedure with the network node, a first transmission including a first PRACH preamble of the multiple PRACH preambles and a second transmission including a second PRACH preamble of the multiple PRACH preambles, the first transmission and the second transmission being a respective first message of the RACH procedure and/or not a retransmission of the first message as described above.

Process 800 may include additional aspects, such as any single aspect or any combination of aspects described below and/or in connection with one or more other processes described elsewhere herein.

In a first aspect, transmitting the first transmission and the second transmission includes transmitting the first transmission and the second transmission using at least one of different time domain ROs for the first transmission and the second transmission, different frequency domain ROs for the first transmission and the second transmission, or a same RO for the first transmission and the second transmission.

In a second aspect, process 800 includes receiving a response message to at least one of the first transmission or the second transmission, the response message including an uplink grant for a third transmission of the RACH procedure.

In a third aspect, process 800 includes retransmitting the first transmission using a first power ramp in connection with failing to detect any response message to both the first transmission and the second transmission, and retransmitting the second transmission using a second power ramp in connection with failing to detect any response message to both the first transmission and the second transmission.

In a fourth aspect, process 800 includes receiving a first response message to the first transmission, the first response message including a first uplink grant, receiving a second response message to the second transmission, the second response message including a second uplink grant, and transmitting, as part of the RACH procedure, a third transmission using one of the first uplink grant or the second uplink grant.

In a fifth aspect, process 800 includes receiving a response message to the first transmission, the response message indicating a first timing advance and a first uplink grant associated with the first timing advance, and a second timing advance and a second uplink grant associated with the second timing advance.

In a sixth aspect, process 800 includes receiving a first response message to the first transmission, the first response message indicating a first timing advance and a first uplink grant associated with the first timing advance, and a second timing advance and a second uplink grant associated with the second timing advance, receiving a second response message to the second transmission, the second response message indicating a third timing advance and a third uplink grant associated with the third timing advance, selecting one of the first uplink grant, the second uplink grant, or the third uplink grant based at least in part on a common timing advance, the common timing advance being derived based at least in part on a comparison between the first timing advance, the second timing advance, and the third timing advance, and transmitting, as part of the RACH procedure, a third transmission using the selected one of the first uplink grant, the second uplink grant, or the third uplink grant.

In a seventh aspect, the common timing advance is based at least in part on the second timing advance in the first response message and the third timing advance in the second response message, and selecting the one of the first uplink grant, the second uplink grant, or the third uplink grant based at least in part on the common timing advance includes selecting the third uplink grant indicated in the second response message.

In an eighth aspect, the common timing advance is based at least in part on the second timing advance in the first response message and the third timing advance in the second response message, and selecting the one of the first uplink grant, the second uplink grant, or the third uplink grant based at least in part on the common timing advance includes selecting either the second uplink grant indicated in the first response message or the third uplink grant indicated in the second response message.

In a ninth aspect, process 800 includes receiving a first response message to the first transmission, the first response message indicating a first timing advance and a first uplink grant associated with the first timing advance, and a second timing advance and a second uplink grant associated with the second timing advance, receiving a second response message to the second transmission, the second response message indicating a third timing advance and a third uplink grant associated with the third timing advance, and a fourth timing advance and a fourth uplink grant associated with the fourth timing advance, and retransmitting the first transmission using a first power ramp and the second transmission using a second power ramp based at least in part on a determination that no common timing advance is indicated in the first response message and the second response message.

In a tenth aspect, process 800 includes receiving a first response message to the first transmission, the first response message indicating a first timing advance, a second timing advance, and a first uplink grant associated with the first timing advance and the second timing advance, receiving a second response message to the second transmission, the second response message indicating a third timing advance and a second uplink grant associated with the third timing advance, and transmitting, as part of the RACH procedure, a third transmission using the second uplink grant based at least in part on a determination the first uplink grant is associated with a potential uplink collision.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, at a network node or an apparatus of a network node, in accordance with the present disclosure. Example process 900 is an example where the apparatus or the network node (e.g., network node 110) performs operations associated with multiple PRACH preamble transmissions by a UE.

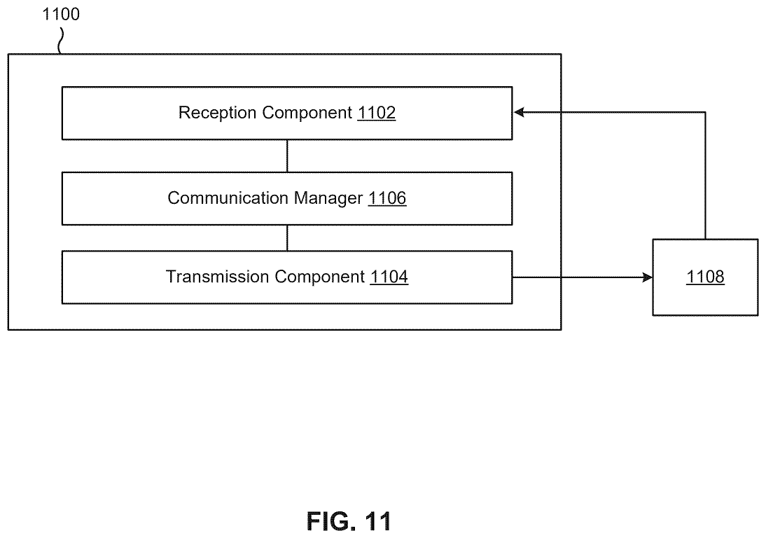

As shown in FIG. 9, in some aspects, process 900 may include receiving a first transmission including a PRACH preamble and a second transmission including the PRACH preamble (block 910). For example, the network node (e.g., using reception component 1102 and/or communication manager 1106, depicted in FIG. 11) may receive a first transmission including a PRACH preamble and a second transmission including the PRACH preamble, as described above.

As further shown in FIG. 9, in some aspects, process 900 may include transmitting a response message associated with the PRACH preamble, the response message including: a first timing advance associated with the first transmission, and a second timing advance associated with the second transmission (block 920). For example, the network node (e.g., using transmission component 1104 and/or communication manager 1106, depicted in FIG. 11) may transmit a response message associated with the PRACH preamble, the response message including: a first timing advance associated with the first transmission, and a second timing advance associated with the second transmission, as described above.

Process 900 may include additional aspects, such as any single aspect or any combination of aspects described below and/or in connection with one or more other processes described elsewhere herein.

In a first aspect, receiving the first transmission and the second transmission includes receiving the first transmission and the second transmission using at least one of different time domain ROs for the first transmission and the second transmission, different frequency domain ROs for the first transmission and the second transmission, or a same RO for the first transmission and the second transmission.

In a second aspect, process 900 includes detecting a collision between the first transmission and the second transmission, and allocating, based at least in part on detecting the collision, a first uplink grant that is associated with the first transmission and a second uplink grant that is associated with the second transmission, the response message indicating that the first uplink grant is associated with the first timing advance and that the second uplink grant is associated with the second timing advance.

In a third aspect, the PRACH preamble is a first PRACH preamble of multiple PRACH preambles indicated by the network node in system information, the response message is a first response message, and process 900 includes receiving a third transmission including a second PRACH preamble of the multiple PRACH preambles, transmitting a second response message to the third transmission, the second response message including a third uplink grant, and receiving, as part of a RACH procedure, a fourth transmission using one of the first uplink grant, the second uplink grant, or the third uplink grant.

In a fourth aspect, the PRACH preamble is a first PRACH preamble of multiple PRACH preambles indicated by the network node in system information, the response message is a first response message, and process 900 includes receiving a third transmission indicating a second PRACH preamble of the multiple PRACH preambles, receiving a fourth transmission indicating the second PRACH preamble, and transmitting a second response message that indicates a third timing advance associated with the third transmission and a third uplink grant associated with the third timing advance, and a fourth timing advance associated with the fourth transmission and a fourth uplink grant associated with the fourth timing advance.

In a fifth aspect, the PRACH preamble is a first PRACH preamble of multiple PRACH preambles indicated by the network node in system information, the response message is a first response message that indicates a first uplink grant associated with the first timing advance and the second timing advance, and process 900 includes receiving a third transmission indicating a second PRACH preamble of the multiple PRACH preambles, and transmitting a second response message to the third transmission, the second response message indicating a third timing advance associated with the third transmission and a second uplink grant associated with the third timing advance.

In a sixth aspect, the first response message indicates a first signal power level associated with the first timing advance and a second signal power level associated with the second timing advance.

In a seventh aspect, the first timing advance and the second timing advance are two of multiple timing advances indicated by the response message, the response message indicates an uplink grant, and the uplink grant is associated with each timing advance of the multiple timing advances.

In an eighth aspect, the first timing advance and the second timing advance are two of multiple timing advances indicated by the response message, and the response message indicates a respective uplink grant for each timing advance of the multiple timing advances.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram of an example apparatus 1000 for wireless communication, in accordance with the present disclosure. The apparatus 1000 may be a UE, or a UE may include the apparatus 1000. In some aspects, the apparatus 1000 includes a reception component 1002, a transmission component 1004, and/or a communication manager 1006, which may be in communication with one another (for example, via one or more buses and/or one or more other components). In some aspects, the communication manager 1006 is the communication manager 140 described in connection with FIG. 1. As shown, the apparatus 1000 may communicate with another apparatus 1008, such as a UE or a network node (such as a CU, a DU, an RU, or a base station), using the reception component 1002 and the transmission component 1004.

In some aspects, the apparatus 1000 may be configured to perform one or more operations described herein in connection with FIGS. 4A-7. Additionally, or alternatively, the apparatus 1000 may be configured to perform one or more processes described herein, such as process 800 of FIG. 8, or a combination thereof. In some aspects, the apparatus 1000 and/or one or more components shown in FIG. 10 may include one or more components of the UE described in connection with FIG. 1 and FIG. 2. Additionally, or alternatively, one or more components shown in FIG. 10 may be implemented within one or more components described in connection with FIG. 1 and FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1002 may receive communications, such as reference signals, control information, data communications, or a combination thereof, from the apparatus 1008. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, one or more modems, one or more demodulators, one or more MIMO detectors, one or more receive processors, one or more controllers/processors, one or more memories, or a combination thereof, of the UE described in connection with FIG. 1 and FIG. 2.

The transmission component 1004 may transmit communications, such as reference signals, control information, data communications, or a combination thereof, to the apparatus 1008. In some aspects, one or more other components of the apparatus 1000 may generate communications and may provide the generated communications to the transmission component 1004 for transmission to the apparatus 1008. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1008. In some aspects, the transmission component 1004 may include one or more antennas, one or more modems, one or more modulators, one or more transmit MIMO processors, one or more transmit processors, one or more controllers/processors, one or more memories, or a combination thereof, of the UE described in connection with FIG. 1 and FIG. 2. In some aspects, the transmission component 1004 may be co-located with the reception component 1002 in one or more transceivers.

The communication manager 1006 may support operations of the reception component 1002 and/or the transmission component 1004. For example, the communication manager 1006 may receive information associated with configuring reception of communications by the reception component 1002 and/or transmission of communications by the transmission component 1004. Additionally, or alternatively, the communication manager 1006 may generate and/or provide control information to the reception component 1002 and/or the transmission component 1004 to control reception and/or transmission of communications.

The reception component 1002 may receive system information associated with a network node, the system information indicating multiple PRACH preambles to use for a RACH procedure with the network node. The transmission component 1004 may transmit, as part of the RACH procedure with the network node, a first transmission including a first PRACH preamble of the multiple PRACH preambles and a second transmission including a second PRACH preamble of the multiple PRACH preambles, the first transmission and the second transmission being a respective first message of the RACH procedure and/or not a retransmission of the respective first message.

The reception component 1002 may receive a response message to at least one of the first transmission or the second transmission, the response message including an uplink grant for a third transmission of the RACH procedure. Alternatively, or additionally, the transmission component 1004 may retransmit the first transmission using a first power ramp in connection with failing to detect any response message to both the first transmission and the second transmission. In some aspects, the transmission component 1004 may retransmit the second transmission using a second power ramp in connection with failing to detect any response message to both the first transmission and the second transmission.

The reception component 1002 may receive a first response message to the first transmission, the first response message including a first uplink grant. Alternatively, or additionally, the reception component 1002 may receive a second response message to the second transmission, the second response message including a second uplink grant. In some aspects, the transmission component 1004 may transmit, as part of the RACH procedure, a third transmission using one of the first uplink grant or the second uplink grant. Alternatively, or additionally, the reception component 1002 may receive a response message to the first transmission, the response message indicating a first timing advance and a first uplink grant associated with the first timing advance, and a second timing advance and a second uplink grant associated with the second timing advance.

In some aspects, the reception component 1002 may receive a first response message to the first transmission, the first response message indicating a first timing advance and a first uplink grant associated with the first timing advance, and a second timing advance and a second uplink grant associated with the second timing advance, and a second response message to the second transmission, the second response message indicating a third timing advance and a third uplink grant associated with the third timing advance. The communication manager 1006 may select one of the first uplink grant, the second uplink grant, or the third uplink grant based at least in part on a common timing advance, and the common timing advance is derived based at least in part on a comparison between the first timing advance, the second timing advance, and the third timing advance. In some aspects, the transmission component 1004 may transmit, as part of the RACH procedure, a third transmission using the selected one of the first uplink grant, the second uplink grant, or the third uplink grant.

The reception component 1002 may receive a first response message to the first transmission, the first response message indicating a first timing advance and a first uplink grant associated with the first timing advance, and a second timing advance and a second uplink grant associated with the second timing advance. Alternatively, or additionally, the reception component 1002 may receive a second response message to the second transmission, the second response message indicating a third timing advance and a third uplink grant associated with the third timing advance, and a fourth timing advance and a fourth uplink grant associated with the fourth timing advance. In some aspects, the transmission component 1004 may retransmit the first transmission using a first power ramp and the second transmission using a second power ramp based at least in part on a determination that no common timing advance is indicated in the first response message and the second response message.

The reception component 1002 may receive a first response message to the first transmission, the first response message indicating a first timing advance, a second timing advance, and a first uplink grant associated with the first timing advance and the second timing advance. Alternatively, or additionally, the reception component 1002 may receive a second response message to the second transmission, the second response message indicating a third timing advance and a second uplink grant associated with the third timing advance. In some aspects, the transmission component 1004 may transmit, as part of the RACH procedure, a third transmission using the second uplink grant based at least in part on a determination the first uplink grant is associated with a potential uplink collision.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

FIG. 11 is a diagram of an example apparatus 1100 for wireless communication, in accordance with the present disclosure. The apparatus 1100 may be a network node, or a network node may include the apparatus 1100. In some aspects, the apparatus 1100 includes a reception component 1102, a transmission component 1104, and/or a communication manager 1106, which may be in communication with one another (for example, via one or more buses and/or one or more other components). In some aspects, the communication manager 1106 is the communication manager 150 described in connection with FIG. 1. As shown, the apparatus 1100 may communicate with another apparatus 1108, such as a UE or a network node (such as a CU, a DU, an RU, or a base station), using the reception component 1102 and the transmission component 1104.

In some aspects, the apparatus 1100 may be configured to perform one or more operations described herein in connection with FIGS. 4A-7. Additionally, or alternatively, the apparatus 1100 may be configured to perform one or more processes described herein, such as process 900 of FIG. 9, or a combination thereof. In some aspects, the apparatus 1100 and/or one or more components shown in FIG. 11 may include one or more components of the network node described in connection with FIG. 1 and FIG. 2. Additionally, or alternatively, one or more components shown in FIG. 11 may be implemented within one or more components described in connection with FIG. 1 and FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, one or more modems, one or more demodulators, one or more MIMO detectors, one or more receive processors, one or more controllers/processors, one or more memories, or a combination thereof, of the network node described in connection with FIG. 1 and FIG. 2. In some aspects, the reception component 1102 and/or the transmission component 1104 may include or may be included in a network interface. The network interface may be configured to obtain and/or output signals for the apparatus 1100 via one or more communications links, such as a backhaul link, a midhaul link, and/or a fronthaul link.

The transmission component 1104 may transmit communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1108. In some aspects, the transmission component 1104 may include one or more antennas, one or more modems, one or more modulators, one or more transmit MIMO processors, one or more transmit processors, one or more controllers/processors, one or more memories, or a combination thereof, of the network node described in connection with FIG. 1 and FIG. 2. In some aspects, the transmission component 1104 may be co-located with the reception component 1102 in one or more transceivers.

The communication manager 1106 may support operations of the reception component 1102 and/or the transmission component 1104. For example, the communication manager 1106 may receive information associated with configuring reception of communications by the reception component 1102 and/or transmission of communications by the transmission component 1104. Additionally, or alternatively, the communication manager 1106 may generate and/or provide control information to the reception component 1102 and/or the transmission component 1104 to control reception and/or transmission of communications.

The reception component 1102 may receive a first transmission including a PRACH preamble and a second transmission including the PRACH preamble. The transmission component 1104 may transmit a response message associated with the PRACH preamble, the response message including a first timing advance associated with the first transmission, and a second timing advance associated with the second transmission.

The communication manager 1106 may detect a collision between the first transmission and the second transmission. In some aspects, the communication manager 1106 may allocate, based at least in part on detecting the collision, a first uplink grant that is associated with the first transmission and a second uplink grant that is associated with the second transmission, and the response message indicates that the first uplink grant is associated with the first timing advance and that the second uplink grant is associated with the second timing advance.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

The following provides an overview of some Aspects of the present disclosure:

Aspect 1: A method of wireless communication performed by a user equipment (UE), comprising: receiving, by the UE, system information associated with a network node, the system information indicating multiple physical random access channel (PRACH) preambles to use for a random access channel (RACH) procedure with the network node; and transmitting, by the UE and as part of the RACH procedure with the network node, a first transmission comprising a first PRACH preamble of the multiple PRACH preambles and a second transmission comprising a second PRACH preamble of the multiple PRACH preambles.

Aspect 2: The method of Aspect 1, wherein transmitting the first transmission and the second transmission comprises: transmitting the first transmission and the second transmission using at least one of: different time domain random access occasions (ROs) for the first transmission and the second transmission, different frequency domain ROs for the first transmission and the second transmission, or a same RO for the first transmission and the second transmission.

Aspect 3: The method of any of Aspects 1-2, further comprising: receiving a response message to at least one of the first transmission or the second transmission, the response message comprising an uplink grant for a third transmission of the RACH procedure.

Aspect 4: The method of any of Aspects 1-3, further comprising: retransmitting the first transmission using a first power ramp in connection with failing to detect any response message to both the first transmission and the second transmission; and retransmitting the second transmission using a second power ramp in connection with failing to detect any response message to both the first transmission and the second transmission.

Aspect 5: The method of any of Aspects 1-4, further comprising: receiving a first response message to the first transmission, the first response message comprising a first uplink grant; receiving a second response message to the second transmission, the second response message comprising a second uplink grant; and transmitting, as part of the RACH procedure, a third transmission using one of the first uplink grant or the second uplink grant.

Aspect 6: The method of any of Aspects 1-5, further comprising: receiving a response message to the first transmission, the response message indicating: a first timing advance and a first uplink grant associated with the first timing advance, and a second timing advance and a second uplink grant associated with the second timing advance.

Aspect 7: The method of any of Aspects 1-6, further comprising: receiving a first response message to the first transmission, the first response message indicating: a first timing advance and a first uplink grant associated with the first timing advance, and a second timing advance and a second uplink grant associated with the second timing advance; receiving a second response message to the second transmission, the second response message indicating: a third timing advance and a third uplink grant associated with the third timing advance; selecting one of the first uplink grant, the second uplink grant, or the third uplink grant based at least in part on a common timing advance, wherein the common timing advance is derived based at least in part on a comparison between the first timing advance, the second timing advance, and the third timing advance; and transmitting, as part of the RACH procedure, a third transmission using the selected one of the first uplink grant, the second uplink grant, or the third uplink grant.

Aspect 8: The method of Aspect 7, wherein the common timing advance is based at least in part on the second timing advance in the first response message and the third timing advance in the second response message, and wherein selecting the one of the first uplink grant, the second uplink grant, or the third uplink grant based at least in part on the common timing advance comprises: selecting the third uplink grant indicated in the second response message.

Aspect 9: The method of Aspect 7, wherein the common timing advance is based at least in part on the second timing advance in the first response message and the third timing advance in the second response message, and wherein selecting the one of the first uplink grant, the second uplink grant, or the third uplink grant based at least in part on the common timing advance comprises: selecting either the second uplink grant indicated in the first response message or the third uplink grant indicated in the second response message.

Aspect 10: The method of any of Aspects 1-9, further comprising: receiving a first response message to the first transmission, the first response message indicating: a first timing advance and a first uplink grant associated with the first timing advance, and a second timing advance and a second uplink grant associated with the second timing advance; receiving a second response message to the second transmission, the second response message indicating: a third timing advance and a third uplink grant associated with the third timing advance, and a fourth timing advance and a fourth uplink grant associated with the fourth timing advance; and retransmitting the first transmission using a first power ramp and the second transmission using a second power ramp based at least in part on a determination that no common timing advance is indicated in the first response message and the second response message.

Aspect 11: The method of any of Aspects 1-10, further comprising: receiving a first response message to the first transmission, the first response message indicating: a first timing advance, a second timing advance, and a first uplink grant associated with the first timing advance and the second timing advance; receiving a second response message to the second transmission, the second response message indicating: a third timing advance and a second uplink grant associated with the third timing advance; and transmitting, as part of the RACH procedure, a third transmission using the second uplink grant based at least in part on a determination the first uplink grant is associated with a potential uplink collision.

Aspect 12: A method of wireless communication performed by a network node, comprising: receiving a first transmission comprising a physical random access channel (PRACH) preamble and a second transmission comprising the PRACH preamble; and transmitting a response message associated with the PRACH preamble, the response message comprising: a first timing advance associated with the first transmission, and a second timing advance associated with the second transmission.

Aspect 13: The method of Aspect 12, wherein receiving the first transmission and the second transmission comprises: receiving the first transmission and the second transmission using at least one of: different time domain random access opportunities (ROs) for the first transmission and the second transmission, different frequency domain ROs for the first transmission and the second transmission, or a same RO for the first transmission and the second transmission.

Aspect 14: The method of any of Aspects 12-13, further comprising: detecting a collision between the first transmission and the second transmission; and allocating, based at least in part on detecting the collision, a first uplink grant that is associated with the first transmission and a second uplink grant that is associated with the second transmission, wherein the response message indicates that the first uplink grant is associated with the first timing advance and that the second uplink grant is associated with the second timing advance.

Aspect 15: The method of Aspect 14, wherein the PRACH preamble is a first PRACH preamble of multiple PRACH preambles indicated by the network node in system information, wherein the response message is a first response message, and wherein the method further comprises: receiving a third transmission comprising a second PRACH preamble of the multiple PRACH preambles; transmitting a second response message to the third transmission, the second response message comprising a third uplink grant; and receiving, as part of a random access channel (RACH) procedure, a fourth transmission using one of the first uplink grant, the second uplink grant, or the third uplink grant.

Aspect 16: The method of any of Aspects 12-15, wherein the PRACH preamble is a first PRACH preamble of multiple PRACH preambles indicated by the network node in system information, wherein the response message is a first response message, and wherein the method further comprises: receiving a third transmission indicating a second PRACH preamble of the multiple PRACH preambles; receiving a fourth transmission indicating the second PRACH preamble; and transmitting a second response message that indicates: a third timing advance associated with the third transmission and a third uplink grant associated with the third timing advance, and a fourth timing advance associated with the fourth transmission and a fourth uplink grant associated with the fourth timing advance.

Aspect 17: The method of any of Aspects 12-16, wherein the PRACH preamble is a first PRACH preamble of multiple PRACH preambles indicated by the network node in system information, wherein the response message is a first response message, wherein the first response message indicates a first uplink grant associated with the first timing advance and the second timing advance, and wherein the method further comprises: receiving a third transmission indicating a second PRACH preamble of the multiple PRACH preambles; and transmitting a second response message to the third transmission, the second response message indicating: a third timing advance associated with the third transmission and a second uplink grant associated with the third timing advance.

Aspect 18: The method of Aspect 17, wherein the first response message indicates a first signal power level associated with the first timing advance and a second signal power level associated with the second timing advance.

Aspect 19: The method of any of Aspects 12-18, wherein the first timing advance and the second timing advance are two of multiple timing advances indicated by the response message, wherein the response message indicates an uplink grant, and wherein the uplink grant is associated with each timing advance of the multiple timing advances.

Aspect 20: The method of any of Aspects 12-19, wherein the first timing advance and the second timing advance are two of multiple timing advances indicated by the response message, and wherein the response message indicates a respective uplink grant for each timing advance of the multiple timing advances.

Aspect 21: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-11.

Aspect 22: An apparatus for wireless communication at a device, the apparatus comprising one or more memories and one or more processors coupled to the one or more memories, the one or more processors configured to cause the device to perform the method of one or more of Aspects 1-11.

Aspect 23: An apparatus for wireless communication, the apparatus comprising at least one means for performing the method of one or more of Aspects 1-11.

Aspect 24: A non-transitory computer-readable medium storing code for wireless communication, the code comprising instructions executable by one or more processors to perform the method of one or more of Aspects 1-11.

Aspect 25: A non-transitory computer-readable medium storing a set of instructions for wireless communication, the set of instructions comprising one or more instructions that, when executed by one or more processors of a device, cause the device to perform the method of one or more of Aspects 1-11.

Aspect 26: A device for wireless communication, the device comprising a processing system that includes one or more processors and one or more memories coupled with the one or more processors, the processing system configured to cause the device to perform the method of one or more of Aspects 1-11.

Aspect 27: An apparatus for wireless communication at a device, the apparatus comprising one or more memories and one or more processors coupled to the one or more memories, the one or more processors individually or collectively configured to cause the device to perform the method of one or more of Aspects 1-11.

Aspect 28: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 12-20.

Aspect 29: An apparatus for wireless communication at a device, the apparatus comprising one or more memories and one or more processors coupled to the one or more memories, the one or more processors configured to cause the device to perform the method of one or more of Aspects 12-20.

Aspect 30: An apparatus for wireless communication, the apparatus comprising at least one means for performing the method of one or more of Aspects 1-20.

Aspect 31: A non-transitory computer-readable medium storing code for wireless communication, the code comprising instructions executable by one or more processors to perform the method of one or more of Aspects 12-20.

Aspect 32: A non-transitory computer-readable medium storing a set of instructions for wireless communication, the set of instructions comprising one or more instructions that, when executed by one or more processors of a device, cause the device to perform the method of one or more of Aspects 12-20.

Aspect 33: A device for wireless communication, the device comprising a processing system that includes one or more processors and one or more memories coupled with the one or more processors, the processing system configured to cause the device to perform the method of one or more of Aspects 12-20.

Aspect 34: An apparatus for wireless communication at a device, the apparatus comprising one or more memories and one or more processors coupled to the one or more memories, the one or more processors individually or collectively configured to cause the device to perform the method of one or more of Aspects 12-20.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based on or otherwise in association with” unless explicitly stated otherwise. Also, as used herein, the term “or” is intended to be inclusive when used in a series and may be used interchangeably with “and/or,” unless explicitly stated otherwise (for example, if used in combination with “either” or “only one of”). It should be understood that “one or more” is equivalent to “at least one.”

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set.

What is claimed is:

1. An apparatus for wireless communication at a user equipment (UE), comprising:
one or more memories; and
one or more processors, the one or more processors, individually or collectively and based at least in part on information stored in the one or more memories, being configured to:
receive system information associated with a network node, the system information indicating multiple physical random access channel (PRACH) preambles to use for a random access channel (RACH) procedure with the network node; and
transmit, as part of the RACH procedure with the network node, a first transmission comprising a first PRACH preamble of the multiple PRACH preambles and a second transmission comprising a second PRACH preamble of the multiple PRACH preambles, the first transmission and the second transmission being a respective first message of the RACH procedure.

2. The apparatus of claim 1, wherein the one or more processors, to transmit the first transmission and the second transmission, are configured to:
transmit the first transmission and the second transmission using at least one of:
different time domain random access occasions (ROs) for the first transmission and the second transmission,
different frequency domain ROs for the first transmission and the second transmission, or
a same RO for the first transmission and the second transmission.

3. The apparatus of claim 1, wherein the one or more processors, individually or collectively, are further configured to:
receive a response message to at least one of the first transmission or the second transmission, the response message comprising an uplink grant for a third transmission of the RACH procedure.

4. The apparatus of claim 1, wherein the one or more processors, individually or collectively, are further configured to:
receive a first response message to the first transmission, the first response message comprising a first uplink grant;
receive a second response message to the second transmission, the second response message comprising a second uplink grant; and
transmit, as part of the RACH procedure, a third transmission using one of the first uplink grant or the second uplink grant.

5. The apparatus of claim 1, wherein the one or more processors, individually or collectively, are further configured:
receive a response message to the first transmission, the response message indicating:
a first timing advance and a first uplink grant associated with the first timing advance, and
a second timing advance and a second uplink grant associated with the second timing advance.

6. The apparatus of claim 1, wherein the one or more processors, individually or collectively, are further configured to:
receive a first response message to the first transmission, the first response message indicating:
a first timing advance and a first uplink grant associated with the first timing advance, and
a second timing advance and a second uplink grant associated with the second timing advance;
receive a second response message to the second transmission, the second response message indicating:
a third timing advance and a third uplink grant associated with the third timing advance;
select one of the first uplink grant, the second uplink grant, or the third uplink grant based at least in part on a common timing advance, wherein the common timing advance is derived based at least in part on a comparison between the first timing advance, the second timing advance, and the third timing advance; and
transmit, as part of the RACH procedure, a third transmission using the selected one of the first uplink grant, the second uplink grant, or the third uplink grant.

7. The apparatus of claim 1, wherein the one or more processors, individually or collectively, are further configured to:
receive a first response message to the first transmission, the first response message indicating:
a first timing advance and a first uplink grant associated with the first timing advance, and
a second timing advance and a second uplink grant associated with the second timing advance;
receive a second response message to the second transmission, the second response message indicating:
a third timing advance and a third uplink grant associated with the third timing advance, and
a fourth timing advance and a fourth uplink grant associated with the fourth timing advance; and
retransmit the first transmission using a first power ramp and the second transmission using a second power ramp based at least in part on a determination that no common timing advance is indicated in the first response message and the second response message.

8. The apparatus of claim 1, wherein the one or more processors, individually or collectively, are further configured to:
receive a first response message to the first transmission, the first response message indicating:
a first timing advance,
a second timing advance, and
a first uplink grant associated with the first timing advance and the second timing advance;
receive a second response message to the second transmission, the second response message indicating:
a third timing advance and a second uplink grant associated with the third timing advance; and
transmit, as part of the RACH procedure, a third transmission using the second uplink grant based at least in part on a determination the first uplink grant is associated with a potential uplink collision.

9. An apparatus for wireless communication at a network node, comprising:
one or more memories; and
one or more processors, the one or more processors, individually or collectively and based at least in part on information stored in the one or more memories, being configured to:
receive, by the apparatus, a first transmission comprising a physical random access channel (PRACH) preamble and a second transmission comprising the PRACH preamble; and
transmit, by the apparatus, a response message associated with the PRACH preamble, the response message comprising:
a first timing advance associated with the first transmission, and
a second timing advance associated with the second transmission.

10. The apparatus of claim 9, wherein the one or more processors, to receive the first transmission and the second transmission, are configured to:
receive the first transmission and the second transmission using at least one of:
different time domain random access opportunities (ROs) for the first transmission and the second transmission,
different frequency domain ROs for the first transmission and the second transmission, or
a same RO for the first transmission and the second transmission.

11. The apparatus of claim 9, wherein the one or more processors, individually or collectively, are further configured to:
detect a collision between the first transmission and the second transmission; and
allocate, based at least in part on detecting the collision, a first uplink grant that is associated with the first transmission and a second uplink grant that is associated with the second transmission,
wherein the response message indicates that the first uplink grant is associated with the first timing advance and that the second uplink grant is associated with the second timing advance.

12. The apparatus of claim 9, wherein the PRACH preamble is a first PRACH preamble of multiple PRACH preambles indicated by the network node in system information,
wherein the response message is a first response message, and
wherein the one or more processors, individually or collectively, are further configured to:
receive a third transmission indicating a second PRACH preamble of the multiple PRACH preambles;
receive a fourth transmission indicating the second PRACH preamble; and
transmit a second response message that indicates:
a third timing advance associated with the third transmission and a third uplink grant associated with the third timing advance, and
a fourth timing advance associated with the fourth transmission and a fourth uplink grant associated with the fourth timing advance.

13. The apparatus of claim 9, wherein the PRACH preamble is a first PRACH preamble of multiple PRACH preambles indicated by the network node in system information,
wherein the response message is a first response message,
wherein the first response message indicates a first uplink grant associated with the first timing advance and the second timing advance, and
wherein the one or more processors, individually or collectively, are further configured to:
receive a third transmission indicating a second PRACH preamble of the multiple PRACH preambles; and
transmit a second response message to the third transmission, the second response message indicating:
a third timing advance associated with the third transmission and a second uplink grant associated with the third timing advance.

14. The apparatus of claim 9, wherein the first timing advance and the second timing advance are two of multiple timing advances indicated by the response message,
wherein the response message indicates an uplink grant, and
wherein the uplink grant is associated with each timing advance of the multiple timing advances.

15. The apparatus of claim 9, wherein the first timing advance and the second timing advance are two of multiple timing advances indicated by the response message, and
wherein the response message indicates a respective uplink grant for each timing advance of the multiple timing advances.

16. A method of wireless communication performed by a user equipment (UE), comprising:
receiving, by the UE, system information associated with a network node, the system information indicating multiple physical random access channel (PRACH) preambles to use for a random access channel (RACH) procedure with the network node; and
transmitting, by the UE and as part of the RACH procedure with the network node, a first transmission comprising a first PRACH preamble of the multiple PRACH preambles and a second transmission comprising a second PRACH preamble of the multiple PRACH preambles, the first transmission and the second transmission being a respective first message of the RACH procedure.

17. The method of claim 16, wherein transmitting the first transmission and the second transmission comprises:
transmitting the first transmission and the second transmission using at least one of:
different time domain random access occasions (ROs) for the first transmission and the second transmission,
different frequency domain ROs for the first transmission and the second transmission, or
a same RO for the first transmission and the second transmission.

18. The method of claim 16, further comprising:
receiving a response message to at least one of the first transmission or the second transmission, the response message comprising an uplink grant for a third transmission of the RACH procedure.

19. The method of claim 16, further comprising:
retransmitting the first transmission using a first power ramp in connection with failing to detect any response message to both the first transmission and the second transmission; and
retransmitting the second transmission using a second power ramp in connection with failing to detect any response message to both the first transmission and the second transmission.

20. The method of claim 16, further comprising:
receiving a first response message to the first transmission, the first response message comprising a first uplink grant;
receiving a second response message to the second transmission, the second response message comprising a second uplink grant; and
transmitting, as part of the RACH procedure, a third transmission using one of the first uplink grant or the second uplink grant.

21. The method of claim 16, further comprising:
receiving a response message to the first transmission, the response message indicating:
a first timing advance and a first uplink grant associated with the first timing advance, and
a second timing advance and a second uplink grant associated with the second timing advance.

22. The method of claim 16, further comprising:
receiving a first response message to the first transmission, the first response message indicating:
a first timing advance and a first uplink grant associated with the first timing advance, and
a second timing advance and a second uplink grant associated with the second timing advance;
receiving a second response message to the second transmission, the second response message indicating:
a third timing advance and a third uplink grant associated with the third timing advance;
selecting one of the first uplink grant, the second uplink grant, or the third uplink grant based at least in part on a common timing advance, wherein the common timing advance is derived based at least in part on a comparison between the first timing advance, the second timing advance, and the third timing advance; and
transmitting, as part of the RACH procedure, a third transmission using the selected one of the first uplink grant, the second uplink grant, or the third uplink grant.

23. The method of claim 16, further comprising:
receiving a first response message to the first transmission, the first response message indicating:
a first timing advance and a first uplink grant associated with the first timing advance, and
a second timing advance and a second uplink grant associated with the second timing advance;
receiving a second response message to the second transmission, the second response message indicating:
a third timing advance and a third uplink grant associated with the third timing advance, and
a fourth timing advance and a fourth uplink grant associated with the fourth timing advance; and
retransmitting the first transmission using a first power ramp and the second transmission using a second power ramp based at least in part on a determination that no common timing advance is indicated in the first response message and the second response message.

24. The method of claim 16, further comprising:
receiving a first response message to the first transmission, the first response message indicating:
a first timing advance,
a second timing advance, and
a first uplink grant associated with the first timing advance and the second timing advance;
receiving a second response message to the second transmission, the second response message indicating:
a third timing advance and a second uplink grant associated with the third timing advance; and
transmitting, as part of the RACH procedure, a third transmission using the second uplink grant based at least in part on a determination the first uplink grant is associated with a potential uplink collision.

25. A method of wireless communication performed by a network node, comprising:
receiving a first transmission comprising a physical random access channel (PRACH) preamble and a second transmission comprising the PRACH preamble; and
transmitting a response message associated with the PRACH preamble, the response message comprising:
a first timing advance associated with the first transmission, and
a second timing advance associated with the second transmission.

26. The method of claim 25, wherein receiving the first transmission and the second transmission comprises:
receiving the first transmission and the second transmission using at least one of:
different time domain random access opportunities (ROs) for the first transmission and the second transmission,
different frequency domain ROs for the first transmission and the second transmission, or
a same RO for the first transmission and the second transmission.

27. The method of claim 25, further comprising:
detecting a collision between the first transmission and the second transmission; and
allocating, based at least in part on detecting the collision, a first uplink grant that is associated with the first transmission and a second uplink grant that is associated with the second transmission,
wherein the response message indicates that the first uplink grant is associated with the first timing advance and that the second uplink grant is associated with the second timing advance.

28. The method of claim 25, wherein the PRACH preamble is a first PRACH preamble of multiple PRACH preambles indicated by the network node in system information,
wherein the response message is a first response message, and
wherein the method further comprises:
receiving a third transmission indicating a second PRACH preamble of the multiple PRACH preambles;
receiving a fourth transmission indicating the second PRACH preamble; and
transmitting a second response message that indicates:
a third timing advance associated with the third transmission and a third uplink grant associated with the third timing advance, and
a fourth timing advance associated with the fourth transmission and a fourth uplink grant associated with the fourth timing advance.

29. The method of claim 25, wherein the first timing advance and the second timing advance are two of multiple timing advances indicated by the response message,
wherein the response message indicates an uplink grant, and
wherein the uplink grant is associated with each timing advance of the multiple timing advances.

30. The method of claim 25, wherein the first timing advance and the second timing advance are two of multiple timing advances indicated by the response message, and
wherein the response message indicates a respective uplink grant for each timing advance of the multiple timing advances.
